(19) United States
(12) Patent Application Publication
(10) Pub. No.: US 2026/0235445 A1
(43) Pub. Date: Aug. 13, 2026

(54) POLARIMETRIC PHASE IMAGING

(71) Applicants: Centre National de la Recherche Scientifique, PARIS (FR); UNIVERSITE PARIS CITE, PARIS (FR); ECOLE CENTRALE DE MARSEILLE, MARSEILLE (FR)

(72) Inventors: Pascal BERTO, PARIS (FR); Baptiste BLOCHET, VINCENNES (FR); Miguel Angel ALONSO GONZALEZ, Marseille (FR); Marc GUILLON, Versailles (FR)

(21) Appl. No.: 19/151,158

(22) PCT Filed: Jan. 30, 2024
(86) PCT No.: PCT/EP2024/052271

§ 371 Date: Jul. 25, 2025

(30) Foreign Application Priority Data
Jan. 30, 2023 (EP) 23305117.6

(51) Int. Cl. G01J 4/04; G01J 9/00; G01J 9/02

(52) U.S. Cl. CPC G01J 4/04; G01J 9/02; G01J 2009/002; G01J 2009/0261

(57) ABSTRACT

A method for generating data related at least to the polarization state and the polarization rate, and advantageously to the wavefront shapes, of an incident light beam of any polarization state and any polarization rate, from a single intensity image acquisition Iₛₑₙₛₒᵣ of said light beam, using a polarization and wavefront shape imaging system which comprises a polarization modulating mask being a diffractive optical element, and an intensity sensor camera, the method comprising: (A) having previously recorded one set of at least four reference intensity patterns, (B) recording the single intensity image Iₛₑₙₛₒᵣ of said incident light beam, (C) processing the single intensity image I based on the reference intensity patterns to generate the data related to the polarization state and the polarization rate, and advantageously to the wavefront shapes of the incident light beam.

### FIELD OF THE INVENTION

The present invention relates to a method for the polarimetric and the wavefront characterizations of a light beam and to a related system.

### PRIOR ART

An optical light beam is defined by its intensity, its wavelength (or spectrum), its phase, and its polarization state. Because of the fast oscillation of optical light, any optical detector (such as cameras or human eyes) can only measure intensity. Any other light parameters (spectrum, phase, polarization state) can only be obtained by combining intensity detectors to other optical devices. Neither camera sensors or the eyes are sensitive to the polarization state of light.

### Wavefront Sensors

Typical wavefront sensors measure the wavefront (or the “spatial phase”) of a beam by placing a so-called “Hartmann mask” before an intensity camera. The role of the Hartmann mask is to encode a phase information into an intensity modulation.

Measuring the spatial phase of a beam finds applications in many fields ranging from optics and laser metrology to quantitative imaging of biological samples and even complex optical fields, for example nanoparticle tracking in super-resolution microscopy.

EP20305898 describes a method for analysing the wavefront-gradient data of a light beam, notably measured using a wavefront sensor, the light beam containing at least one optical vortex, in order to estimate the contribution of the optical vortices to the wavefront.

EP20705986 and EP20306121 describe measuring several wavefronts simultaneously allowing measuring the spectral wavefront, which means the spatial phase at each wavelength of the beam spectrum. Simultaneous multiplexed hyper-spectral measurement is not only practical but is mandatory in some applications such as ultrashort laser metrology and no technology has been commercialized so far.

### Polarization Imaging

The polarization state of a beam corresponds to the geometry with which the vector electric field oscillates. The polarization state of a beam is defined by the oscillation amplitude in two orthogonal directions together with their relative phase. The full determination of the polarization state of a beam requires at least four intensity measurements. The polarization state of a beam is fully defined by so-called “Stokes' parameters”: S₀ (the beam intensity), S₁, S₂ and S₃ (handedness and eccentricity of elliptic polarization).

The polarization state of a light beam gives information about symmetry breaking at the molecular and micrometric scales: structures with specific orientations (or chirality) will interact differently for two orthogonal linear (resp. circular) polarized beams. It also allows characterizing the material and the surface structure of objects onto which the light is reflected. This possibility has been investigated for target recognition applications.

Polarization imaging finds applications in meteorology and marine biology. The density and nature of small scattering particles such as in clouds or micro-organisms in water can be characterized by measuring the polarization state of transmitted or back-scattered light. Polarization imaging also find applications for monitoring surface corrosion and non-invasive damage inspection. In biology or chemistry, polarized spectroscopy can be used to characterize inorganic molecules and particles.

Camera sensors (e.g. Sony IMX250MZR, IMX253MZR) already exist to measure the polarization state of a beam, but their measure is incomplete and sacrifice half the impinging energy. They can almost completely measure the 4 Stokes parameters for a fully polarized beam, only the sign of S3 remains undetermined. The determination of the handedness of circular polarization, sign of S3, is of critical importance to study circular birefringence of materials, associated with molecules chirality. Furthermore, S3 remains completely undetermined for partially polarized beams. Consequently, in this case, both the rate of polarization “p” and the handedness of the polarization state are unknown. Such sensors could be trivially combined to Hartmann masks to provide the wavefront of the beam in addition to the incomplete polarization state.

Alternatively, K. Oka & T. Kanedo proposed using birefringent wedge-assemblies placed in the close vicinity of the camera sensor (Opt Express 11(13) 1510 (2003)) to perform full Stokes polarimetry. In this configuration, the wedges are used to induce an angle between cross-polarized states of the impinging beam so resulting in fringes at the camera plane through a polarization analyser. Polarimetric information is then encoded in the fringe contrast modulation and can be analysed by Fourier transforming the recorded intensity image at the camera. However, because of the wedges thicknesses, not only an angle is introduced but a transverse shift also, so that all images of all polarization states do not perfectly overlap. For this reason, this instrument is presented by K. Oka and N. Saito as exhibiting “remarkable features [for] its simpleness and compactness” but “not pertinent for the high spatial resolution measurement because of the problems related to the beam-splitting at the birefringent wedge prisms” (Proc. of SPIE Vol. 6295, 629508, (2006)).

In this latter work, as an improvement, K. Oka and N. Saito thus propose a polarimetric sensor based on a pair of Savart plates together with a quarter wave-plate placed at infinity, in a Fourier plane, with respect to the observation plane of the camera (Proc. of SPIE Vol. 6295, 629508, (2006)). Each Savart plate induces a shear (i.e. a “transverse shift”) between the two beams of cross-polarized field components, so resulting in fringes in the Fourier plane of a lens, at the camera plane, when passing through a polarization analyser. Polarization information is then similarly encoded in the fringe pattern with the improvement that images of different polarization states can now perfectly overlap at the camera plane. In this approach, the spatial modulation frequency at the camera plane, proportional to the shear, must be large enough so that the Fourier replica of the object spectrum (created by the fringe modulation) do not overlap. Therefore, the larger the fringe modulation frequency, the better the spatial resolution of the polarimetric image.

One important drawback of using pairs of birefringent crystals such as wedges or Savart plates in both former implementations is related to the significant optical path delay introduced between the two cross-polarized components of the impinging beam. The optical path delay is proportional to the shear and/or tilt introduced by the crystals (and thus to the crystal thickness), making these systems incompatible with broadband light sources.

To improve the spectral width of these instruments, M. Kudenov et al. (Appl. Opt. 50(15) 2283 (2011)) suggested to replace the Savart plates by pairs of polarization gratings, also placed at infinity, in a Fourier plane, with respect to the observation plane of the camera. The shear between the two cross-polarized components of the impinging beam is then proportional to the separation distance between the two gratings, and thus, to the mask thickness. Advantageously, this design yields almost achromatic optical path delays between the ordinary and the extraordinary rays, especially when exploiting the Pancharatnam-Berry geometric phase modulation principle. Such optical elements consists in thick polarization-optic assemblies that could not be placed at the camera plane without any significant degradation of the spatial resolution.

Polarimetry also finds a large amount of applications to measure the Mueller matrix in biology or agriculture, as described in the article Ignatenko, D. (2022). Applications of Mueller Matrix Polarimetry to Biological and Agricultural Diagnostics: A Review. Appl. Sci., 12(10), pp.5258. The Mueller matrix M indeed, relates the Stokes vector S₀ᵤₜ containing all four Stokes parameters (S0, S1, S2, S3) of the outgoing light beam to the Stokes vector Sᵢₙ. of the impinging beam according to S₀ᵤₜ=M*Sᵢₙ, and thus involve a rich content about the tissue. Mueller matrix polarimetry typically demands a polarization state generator for the impinging beam and a polarization state analyser for the outgoing beam.

A beam can be fully polarized, in which case Stokes parameters satisfy:

$${S}_{0} = \sqrt{{S}_{1}^{2} + {S}_{2}^{2} + {S}_{3}^{2}} .$$

A beam can also be fully non-polarized in which case S₁=S₂=S₃=0 although S₀≠0. The most general case is a partially polarized beam for which the rate of polarization is

$$p = \frac{\sqrt{{S}_{1}^{2} + {S}_{2}^{2} + {S}_{3}^{2}}}{{S}_{0}} .$$

Hereafter, a polarization modulating mask is defined as a mask which induces a spatial modulation of the polarization state of an input beam, this polarization-change so depending on the location of the input beam on the mask. Ideally, this mask should have a transmission coefficient of 1 and should modulate 100% of the input beam. For a fully polarized input beam, the output beam may then be locally either fully polarized, partially polarized or fully non-polarized.

### Polarimetric Phase Imaging

In biology and biomedical applications, biological cells are mostly transparent, meaning that the optical information is chiefly encoded in the phase and the polarization state of the beam.

High-resolution phase imaging based on wavefront sensor technologies allows making quantitative phase imaging a simple plug-in device for biologists, so making it compatible with constrained biological environments. Aknoun, S. (2015) discloses quantitative retardance imaging of biological samples using quadriwave lateral shearing interferometry. Optics Express, 23(12), pp. 16383-16406, describes multi-shots phase and polarization imaging of cells thanks to a high-resolution wavefront imager which considerably simplifies the measurement. However, polarization characterization still requires a quite complex optical illumination and detection system as well as a set of several measurements. The complexity of polarimetric measurements still demands opticians to design optical systems, thus hindering spreading among biologists. Potentialities of imaging polarization contrast is thus under-used in this community although potentially providing a non-invasive label-free contrast ability in many situations.

Yet, quantitative phase imaging has been demonstrated to be highly sensitive to dry mass changes within living cells resulting from refractive index changes with protein concentration. Besides, molecular orientation and thus molecular crowding can be efficiently studied at the nanometric scale in cells thanks to polarized single-molecule localization microscopy, as describes by Shaban, H. A., Valades-Cruz, C. A., Savatier, J. and al. Polarized super-resolution structural imaging inside amyloid fibrils using Thioflavine T. Sci Rep 7, 12482 (2017).

In addition, molecular structuring at the nanoscopic level is intrinsically associated with detectable optical anisotropy, even without any labelling. Through molecular structuring, nano-morphological properties of proteins induce significant light wave delays and polarization changes when light is transmitted through or reflected on such structures. For this reason, polarimetric imaging is also a well-established technique in biological and biomedical imaging, as described in Massoumian, F. (2003) Quantitative polarized light microscopy. Journal of Microscopy, 209 (1), and Ramella-Roman, J. (2020) A review of polarization-based imaging technologies for clinical and preclinical applications. Journal of Optics, 22 (12).

In medicine, phase and polarization imaging are used for diagnosis. For example, bone narrow disorder can be identified by finding amyloid plaque detection in histological slides of cardiac tissue, as described in Dai, X. (2022). Quantitative Jones matrix imaging using vectorial Fourier ptychography. Biomedical Optics Express, 13 (3), pp. 1457-1470. Song, S. (2021). Large-Area, High-Resolution Birefringence Imaging with Polarization-Sensitive Fourier Ptychographic Microscopy. ACS Photonics, 8 (1), pp. 158-165 describes parasite infection in red blood cells generating hemozoin crystal that can be detected with phase and polarization imaging. Similarly, some genetic disorders such as cystinosis induced some protein aggregates that exhibits specific polarization and phase profile, as described in Cherqui, S. (2017) The renal Fanconi syndrome in cystinosis: pathogenic insights and therapeutic perspectives. Nat Rev Nephrol., 13 (2), pp. 115-131.

Simultaneous measurement of the phase and the polarization state of light can be used to characterize the properties of anisotropic nanoparticles or chiral metamaterial devices. For telecommunication, vectorial beams with orbital angular momentum are used for free space tele-communication and could be characterized and sorted out thanks to polarized wavefront sensing. For fibered telecommunication, the full characterization of multimode fibers requires the measurement of phase, polarization, and intensity information.

A single shot polarimetric wavefront sensor can be obtained by adding a Hartmann mask to a polarimetric imager. Typical Hartmann mask are microlens arrays, or diffraction gratings.

Typically, a Hartmann mask can be placed in front of a polarimetric camera sensor based on a division of the focal plane (e.g. Sony IMX250MZR, IMX253MZR). However, to date, no such commercial sensor allows full-Stokes measurements.

A Hartmann mask can also be combined with a fringe-modulating polarimetric imager such as those proposed by K. Oka and coworkers. In particular, such systems can be combined with a microlens array such as proposed in (US 2014/0078298 A1). However, the combination with a modified Hartmann mask (J. Primot & N. Guérineau, Appl. Opt. 39(31) 5715, (2000)) aiming at getting high-resolution phase and polarimetric imaging is far from trivial because both phase and polarization are then encoded in fringe patterns. Special care must then be taken for the spectral components associated with phase and polarization, respectively, do not overlap.

The system proposed by Yang, Z., Wang, Z., Wang, Y. et al. Generalized Hartmann-Shack array of dielectric metalens sub-arrays for polarimetric beam profiling. Nat Commun 9, 4607 (2018), consists in designing micro-lenses with a metasurface to mimick polarization sensitive micro-lenses with a principle identical to the Hartmann-Shack wavefront sensor. This system thus splits the impinging beam into beamlets, each beamlet passing through a meta micro-lens. In more details, the system comprises a unit-cell array of 6 metasurface microlenses focusing 6 different polarization states on a camera sensor (Noteworthy, equivalent results could have been obtained using only 4 metasurface microlenses per unit-cell). The relative ratios of these foci are directly related to the polarization state of the incoming electric field and the displacements of these foci are related to the wavefront gradient of the incoming field.

The retrieval of one measurement of both the local polarization state and the wavefront of the beam is achieved within one entire unit-cell containing the 6 metasurface micro-lenses. The distance between the mask and the camera plane is fixed and dictated by the focal length of the metalenses and the magnification between the mask and the camera is dictated by the size of the foci generated by the microlenses (which must equal the camera pixel size). The cost in terms of number of camera pixels per sampling point is very high because the distance between each sampling point (each focus) equals the size of the unit cell. The required number of camera pixels per sampling point thus scales as the ratio between the focus surface and the microlens surface: 1350 camera pixels are necessary to get 1 sampling point. It is difficult with such a system to achieve a high-resolution mapping of phase and polarization because it would demand cameras with a huge number of pixels. It should also be pointed-out that metallic metasurfaces are more efficient in the near infrared range (around 1.5 um) than in the visible range both because of the resonant structure size scale with the wavelength and because matter absorbs more at shorter wavelengths, especially at resonance. Such a system is thus not well adapted for visible light.

Some already existing sensors can almost completely measure the 4 Stokes parameters for a fully polarized beams, as only the sign of S3 remains undetermined. However, S3 remains completely undetermined for partially polarized beam. Consequently, in this latter case, both the rate of polarization and the handedness of the polarization state are unknown. Noteworthy, the case of partially polarized beams is especially relevant for imaging applications since the use of laser sources in this case yields many interference phenomena degrading the image quality. Broadband light sources are thus typically preferred in this case for which the degree of polarization may degrade when propagating through birefringent materials. These sensors are thus not optimized for quantitative polarimetric imaging applications.

Another existing high-resolution wavefront sensor combined with an active control of the polarization state of the illumination requires multiple images to reconstruct some polarization properties of a sample. It also requires an active illumination which is not compatible with many situations.

Lee, K (2019. Interpreting Intensity Speckle as the Coherency Matrix of Classical Light. Phys. Rev. Applied, 12 (2), uses a scattering media to simultaneously recover the phase and polarization of an incident light field with the knowledge of the polarized resolved transmission matrix and advanced phase retrieval algorithms. The first drawback of this technique is the complex system required to measure the transmission matrix which is not compatible for an “out of the lab” system. Moreover, the required phase retrieval algorithm may be difficult, time consuming and prone to artifacts in some instances.

There is a need for a simple system for simultaneous high-resolution imaging of the phase and the polarimetric parameters of a beam and/or a sample, that can be easily used.

### SUMMARY OF THE INVENTION

The invention makes it possible to overcome at least some of drawbacks of the prior art mentioned above thanks to a method for generating data related at least to the polarization state and the polarization rate, and advantageously to the wavefront shapes, of an incident light beam of any polarization state and any polarization rate, from a single intensity image acquisition Iₛₑₙₛₒᵣ of said light beam, using a polarization and wavefront shape imaging system which comprises a polarization modulating mask and an intensity sensor camera:
the polarization modulating mask being a diffractive optical element having:
   a polarization-resolved transmission or reflection matrix T,
      the property to generate interference patterns between any two cross-polarized impinging beams, at several planes transverse to the propagation axis, the several transverse planes lying at several working distances from said polarization modulating mask,
the interference patterns so depending on the two respective amplitudes and the relative phase of said two cross-polarized impinging beams, and
   the property to generate at least one set of four reference intensity patterns, at least at one working distance from the polarization modulation mask, when illuminated by four respective impinging reference light beams,
the four impinging reference light beams having polarization states defining all together a tetrahedron of non-zero volume when represented on the polarization Poincaré sphere,
each said set of four reference intensity patterns forming a Stokes parameters image basis, meaning that the auto-correlation matrix C_{L}=( [symbol] Rᵢ|Rⱼ [symbol] _{L,G} [symbol] of the corresponding four reference intensity patterns is invertible, Rᵢ being the reference pattern of polarization state i,
the intensity sensor camera being placed downstream from said polarization modulating mask for recording an intensity image of the incident light beam, at least a part of which having preferentially been reflected by or transmitted through the polarization modulating mask, or alternatively at least a part of the incident light beam having preferentially interfered with another beam reflected by or transmitted through the polarization modulating mask, said intensity image lying at any of the several of said working distances from the polarization modulating mask,
   the method comprising:
(A) having previously recorded one set of at least four reference intensity patterns with the intensity sensor camera of the imaging system, the reference intensity patterns being formed at one given of said working distances d from the polarization modulating mask, each reference intensity pattern having been generated by a respective impinging reference light beam of known polarization rate and known polarization state, and advantageously of known wavefront shape, the polarization states of the impinging reference light beams defining all together a polyhedron of non-zero volume when represented on the polarization Poincaré sphere and reference intensity patterns defining a Stokes parameters image basis at the working distance d,
(B) recording the single intensity image Iₛₑₙₛₒᵣ of said incident light beam with the intensity sensor camera, the single intensity image being formed at the same given working distance d from the polarization modulating mask,
(C) processing the single intensity image Iₛₑₙₛₒᵣ based on the reference intensity patterns to generate the data related to the polarization state and the polarization rate, and advantageously to the wavefront shapes of the impinging light beam.

The polarization and wavefront shape imaging system only needs to be calibrated once, the calibration corresponding to the step (A) of the method for generating data related at least to the polarization state and the polarization rate.

The steps (A) and (B) may be achieved in the reverse order.

By “working distance” it must be understood the distance from the input plane of the polarization modulating mask to the camera-sensor plane or, when an intermediate imaging optical instrument is used between the polarization modulating mask and the camera, for example a set of lenses, the working distance designates the distance from the input plane of the modulating mask to the image of the camera sensor plane through the set of lenses.

The input plane of the polarization modulating mask designates the first plane encountered by a beam that exhibits spatially-patterned birefringent optical properties. For instance, in the case of a liquid crystal matrix stacked between two glass slides substrates, the input plane is the first interface between the first glass plate and the liquid crystal layer. For a nanometric birefringent metasurface deposited on, or written inside a glass substrate, the input plane is the plane corresponding to the beginning of the metasurface.

Similarly, the thickness of the polarization modulating mask is defined between its input plane defined above and its output plane, its output plane being similarly defined as the last plane exhibiting spatially patterned birefringent optical properties.

A polarization state is characterized by four Stokes parameters (S₀, S₁, S₂ and S₃). These four parameters can be represented in three dimensions using a so-called Poincaré sphere. The Cartesian axes of this three-dimensional space are S₁, S₂ and S₃. The polarization rate

$$p = \frac{\sqrt{{S}_{1}^{2} + {S}_{2}^{2} + {S}_{3}^{2}}}{{S}_{0}}$$

can be represented as the radius of the sphere. The fourth degree of freedom, namely the total intensity S₀, is not represented in this case.

A polarimetric measurement may demand measuring reference intensities for reference beams having polarization states enclosing a non-zero volume when represented in the Poincaré three-dimensional space. At least four measurements may thus be required to define a non-zero volume in the Poincaré space. This requirement may also be true for the polarization and wavefront shape imaging system. In the latter, each reference beam generate an intensity pattern at the camera plane, downstream of the polarization modulating mask.

One additional requirement may be that the generated four reference intensity patterns define a basis when considering four respective reference beams. This property ensures the sensitivity of the system to any impinging polarization state described by any polarization Stokes vector.

The polarization and wavefront shape imaging system may be a simple “plug-and-play” imaging system, that may measure simultaneously the full polarization state and the corresponding wavefronts of an incident electric field in a single-shot manner. The system may be based on typical wavefront sensors technology, implemented with a polarization modulating mask that may encode both polarization and spatial phase information into intensity modulation.

The method may require no magnification optics between the polarization modulating mask and the camera sensor, which makes the system used to perform the method potentially more compact.

The method allows to obtain high resolution images of the phase and/or full polarization state of a light beam, from a single captured image.

### Intensity Sensor Camera

The intensity sensor camera may be composed of a pixilated surface.

At least one subset of four reference intensity patterns among the at least four reference intensity patterns may have the property to generate an invertible auto-correlation matrix CL.

To allow polarimetric imaging, there is a macro-pixel size M_{P} over which the local cross-correlation matrix

$${C}_{L} = {( 〈 {R}_{i} \vert {R}_{j} 〉 )}_{( i , j ) ∈ 〚 1 , 4 〛} = {[ \overline{( {R}_{i} - \overline{{R}_{i}} ) ( {R}_{j} - \overline{{R}_{j}} )} ]}_{( i , j ) ∈ 〚 1 , 4 〛}$$

of the four reference intensity patterns is invertible, i.e. its determinant is-non-negligible, where th overline stands for the spatial average over one macro-pixel area:

$$\overline{{R}_{k}} = \frac{1}{{M}_{p}} \int {\int }_{{M}_{p}} {R}_{k} ( r ) {d}^{2} r$$

The minimum eigen-value of the matrix C_{L} may not be lower than a few percent of the largest eigen-value of the matrix C_{L}. Preferentially, the four reference intensity patterns are orthogonal relatively to the local zero-mean cross-correlation product.

The auto-correlation matrix C_{L} may be computed over a macro-pixel containing at least one 20×20 camera pixels or less, advantageously 12×12 camera pixels or less, more advantageously 6×6 camera pixels or less, more advantageously 3×3 camera pixels or less.

The number of camera pixels required to get one phase and polarization pixel scale may be (λd/w²)², where λ is the wavelength of the beam, d is the working distance and w is the typical size of the motif of the mask. “One phase and polarization pixel” may be defined here as one sampling point for both the wavefront gradient and the polarization state. Measuring one sampling point demands several intensity measurements which may be obtained at several corresponding nearby pixels of a camera. One phase and polarization pixel may thus spread over several camera pixels.

By “motif of the mask” one means that the mask exhibits structured birefringent regions, or patterns, allowing to modulate spatially both the phase and the polarization state of the impinging beam so that beamlets interfering with different regions of the mask are scattered and interfere together after propagation over a distance d. The typical size of these structured regions w may be estimated by measuring the spatial correlation width of the polarization resolved transmission matrix of the mask. If the mask is a two-dimensional periodic polarization grating, w explicitly refers to one period of the lattice.

A thin polarization modulating mask may be modeled by a polarized-resolved transmission matrix T expressed in an orthonormal basis of polarization states as:

$$T = [ \begin{matrix}{T}_{11} & {T}_{12} \\ {T}_{21} & {T}_{22}\end{matrix} ]$$

where Tᵢⱼ are transmission coefficients that are functions of the position x,y on the mask. One important characteristic of these coefficients is related to their spatial auto-correlation function:

$${C}_{i , j} ( x , y ) = \int \int {T}_{ij} ( u , v ) {T}_{ij}^{*} ( u - {x}_{,} v - y ) dudv$$

This function exhibits a peak with a maximum at position (x,y)=(0,0), and an important property to be considered for wavefront sensing is the dimensions of this peak. These dimensions are usually quantified by measuring the full width at half maximum of the peak.

For the polarization modulating mask, we thus have 4 Cᵢⱼ(x,y) functions having two typical dimensions each. We may consider the smallest full width at half maximum w over auto-correlations of all Tᵢⱼ coefficients. w may be defined as the smallest dimension of the correlation function of transmission matrix T. The mask may diffract light with a typical angle scaling as λ/w or larger, which drives the spatial resolution, i.e. the polarization pixel size, and advantageously the wavefront image pixel size, of the instrument scaling as λd/w where d is the working distance defined as the separation distance between the mask, or its image (by an optical device, for example a set of lenses), and the plane of observation of the camera. The smaller w, the larger the phase pixel size and the worse the spatial phase resolution.

For small enough working distances d, when not in the far field, the intensity structures at the camera plane may be of typical size w or smaller, typically a harmonic fraction of w, in particular p*w/q with p and q integers and p inferior or equal to q, with w the typical size of the motif of the polarization modulating mask. At larger distances, the typical size of intensity structures may become larger than w. In the Fourier plane of a lens, the size of intensity structures may not depend on w but may be governed by the focal length of the lens and the diameter of the beam.

For small enough working distance d, the structures of the intensity patterns may thus be of size w or smaller. These intensity structures may be wanted to be resolved by the pixels of the intensity sensor camera, meaning that w may be wanted to be larger than the camera pixel size.

The number of polarization and/or wavefront sampling points at the camera plane may depend on the working distance d. In fine, the number of sampling points may determine the resolution of the final polarization and/or wavefront images.

The system may work for working distances smaller than the Rayleigh distance z_{R}=πw²/λ, in contrast to a micro-lens that cannot yield a sharp focus at a distance less than the Rayleigh distance. Indeed, for a lens, w=λf/a where a is the diameter of the micro-lens. Having a focal length f smaller than the Rayleigh distance imposes that f>a²/(πλ) which inefficiently focus light because the diffraction by the micro-lens aperture counterbalances focusing. In the limit case of a micro-lens focusing at a distance equal to z_{R}, (λd/w²)²=π²≈10.

The intensity sensor camera may thus be placed so that the intensity image Iₛₑₙₛₒᵣ is lying at a working distance shorter than Rayleigh distance of the mask z_{R}, with z_{R}=πw²/λ_{average}, λ_{average} being the average wavelength of the incident light beam (51).

One purpose of the invention is to provide high-resolution polarization images, and advantageously high-resolution wavefront images. The scaling of the resolution of these images may be discussed as a function of the working distance.

For working distances smaller than the Rayleigh distance z_{R}=πw²/λ, the number of polarization and/or wavefront sampling points over the captor size of the intensity sensor camera may scale as (L/w)², where L is the diagonal length of the captor of the intensity sensor camera, or the diagonal length of the image of the captor through the set of lenses if an intermediate imaging system is present between the mask and the camera. Noteworthy, w should be adjusted to the pixel size of the camera so that the structures of intensity patterns are resolved as argued above.

For working distances larger than the Rayleigh distance z_{R}=πw²/λ, the number of polarization and/or wavefront sampling points over the captor size of the intensity sensor camera may scale as (wL/λ_{averaged})², d being the working distance and L being the diagonal length of the captor of the intensity sensor camera or the diagonal length of the image of the captor through the set of lenses if an intermediate imaging system is present between the mask and the camera. To keep a high-resolution image at working distances larger than the Rayleigh distance, the working distance may thus still remain much smaller than wL/λ_{average}. If the working distance is equal to wL/λ_{average} divided by a factor N, the number of sampling points, and thus of the resolution of the polarization and/or wavefront image, may be N×N. For example, for a working distance smaller than one tenth of wL/λ_{average}, the resolution of the polarization and/or wavefront image will be be 10×10.

The working distance may thus be smaller than one tenth of wL/λ_{average}, with L the diagonal length of a captor of the intensity sensor camera and λ_{average} being the average wavelength of the incident light beam.

To allow phase imaging, the distance between the polarization modulating mask, or its image, and the camera is small enough so that wavefront distortions induce local pattern displacements s much smaller than the aforementioned macro-pixel dimensions. The global cross-correlation matrix C_{L} may remain invertible over the typical displacement amplitude s of typical sought-for wavefronts. Preferentially, the four reference intensity patterns are orthogonal relatively to the global zero-mean cross-correlation product when s runs over the full macro-pixel size.

Global zero-mean cross-correlation product may be arranged in a global auto-correlation matrix potentially defined as:

$${C}_{G} = {( {〈 {R}_{i} \vert {R}_{j} 〉}_{G} )}_{( i , j ) ∈ 〚 1 , 4 〛} = {\{ {max}_{s} [ \int \int {R}_{i} ( r ) {R}_{jj}^{*} ( r - s ) {d}^{2} r ] \}}_{( i , j ) ∈ 〚 1 , 4 〛}$$

The intensity sensor camera may be placed so that the intensity image is lying at a working distance d shorter than πw²/λ_{average}, λ_{average} being the average wavelength of the incident light beam and w being a smallest dimension of auto-correlation functions of the coefficients of the polarization-resolved transmission or reflection matrix T, one auto-correlation function being computed per coefficient.

The intensity sensor camera may be any camera, for instance optimized for fluorescence imaging. The intensity sensor camera may alternatively be a combination of several cameras.

### Polarization Modulating Mask

The polarization modulating mask may reflect or transmit the whole incident light beam. Alternatively, the polarization modulating mask may reflect or transmit only a part of the incident light beam. In another alternative, the polarization modulating mask may not reflect nor transmit the incident light beam.

The polarization modulating mask may be configured so that eₘᵢₙ/eₘₐₓ is greater than 1.5%, better than 1%, wherein eₘᵢₙ and eₘₐₓ are respectively the smallest and the largest eigen-values of the auto-correlation matrix

$${C}_{L} = {( {〈 {F}_{i} \vert {F}_{j} 〉}_{L , G} )}_{( i , j ) ∈ 〚 1 , 2 〛}$$

constructed from both the reference intensity patterns and their respective intensity gradient maps.

The role of the mask is to induce spatially varying changes to the polarization state of the beam. The system relies on the assumption that the correlation width of the beam at the mask plane is larger than the typical size w of the structures of the mask so that nearby beamlets at the mask may yield interference patterns.

The polarization modulating mask may induce interferences between two coherent, but cross-polarized field components of the incident light beam, at the camera plane. Consequently, the intensity pattern at the camera plane may depends on the relative phases and amplitudes between two cross-polarized beams, which means that the intensity pattern may depend on the polarization state of the incident beam.

The polarization modulating mask may be configured to cause the intensity image to depend on the wavefront shape of the incident light beam. A tilt applied to the wavefront shape may result in a displacement of the intensity image.

We define as the angular “memory effect” of the mask, the property to induce a translation of the intensity image under a tilt of the impinging wavefront. This property is typically valid for any thin enough mask. In this case, the translation amount may be proportional to the local wavefront gradient.

The intensity pattern, i.e. the intensity image, created by the mask at the camera plane may be deformed by wavefront distortion, so allowing retrieving also the spatial phase of the beam like in regular wavefront sensors.

The polarization modulating mask may be thinner than one tenth of the Rayleigh distance of the mask z_{R}, with z_{R}=πw²/λ_{average}.

The polarization modulating mask may comprise a two-dimensional birefringent diffraction grating consisting for example in a two-dimensional periodic lattice of at least one transverse period w and based on a unit cell, in particular the diffraction grating exhibiting for each unit cell a patterned diversity of two-dimensional birefringent properties, advantageously with a unit cell being a square cell of side size said period w.

The reference intensity patterns may exhibit structures of size equal to said transverse period w or smaller at the working distance.

The two-dimensional periodic lattice may have any structure of any of the five possible two-dimensional Bravais lattices: oblique lattice, square lattice, rectangular lattice, hexagonal lattice or rhombic lattice. Advantageously, square lattice and/or hexagonal lattice provide isotropic two-dimensional properties, so ensuring isotropic two-dimensional spatial resolution if using an intensity camera sensor having square detecting pixels. In the case the lattice is not square or hexagonal, it may be characterized by at least two transverse spatial periods. The relevant transverse period to be considered in this case may be the smallest one since associated with the smallest Rayleigh length.

The unit cell of the periodic lattice may exhibit spatially patterned birefringent optical properties, that is to say a two-dimensional birefringent motif. The birefringent motif may refer to the spatial structure of the local linear or circular retardance of the mask as well as the local fast axis orientation. For instance, it is possible to perform full Stokes polarimetry with uniform retardance over the unit cell if the fast axis orientation is spatially patterned and exhibit enough orientation diversity. Alternatively, full Stokes polarimetry is also possible with uniform fast axis orientation if circular retardance is spatially patterned and exhibit enough diversity over the unit cell. In the general case, the linear retardance, the circular retardance and the fast axis orientation may be spatially patterned.

The birefringent diffraction grating allows tuning the sensitivity by changing the distance between the mask, or its image, and the camera, since for a given mask, several working distances are possible.

The birefringent modulating mask may work as efficiently in the visible range as in the near infrared range.

The polarization modulating mask, in particular the unit cell, may comprise a plurality of polarization modulating domains, each polarization modulating domain having preferably a uniform polarization-resolved matrix over said polarization modulating domain, the polarization modulating domains being for instance randomly arranged or periodically arranged in a lattice in the unit cell of the polarization modulating mask.

One domain may be as large as three camera pixels or larger. A unit cell made of 2×2 domains may thus be as large as 6×6 camera pixels at least.

One domain may be composed of metallic or dielectric nano-rods.

Each unit cell may comprise four square adjacent polarization modulating domains, preferably arranged in rows and columns, the four square adjacent polarization modulating domains having preferentially a linear retardance of π/2±π/4 rad and/or relative fast axes orientations rotating by {+π/3+π/3 −π/3 −π/3} radians when running around the four adjacent domains clockwise or counter clockwise, the tolerance on fast-axes orientations being preferably ±π/6 rad.

Noteworthy, any uniform rotation of the fast axes orientations inside the unit cell by an angle α may not change the intensity patterns downstream the polarization modulating mask. Therefore the description of a unit cell having relative fast axes orientations rotating by {+π/3+π/3 −π/3 −π/3} radians when running around the four adjacent domains clockwise or counter clockwise may equivalently be described by absolute fast axes orientations given by {α; α+π/3; α+2π/3; α+π/3} radians when running around the four adjacent domains clockwise or counter clockwise, where α is an angle. Noteworthy the angles of fast axes orientations are defined here modulo π.

As an alternative, each unit cell may comprise 16 square adjacent polarization modulating domains arranged in rows and columns.

A unit cell may modulate all polarization components of the light beam, allowing spreading the light energy over the full camera surface, so optimizing the spatial density of sampling point and thus the spatial resolution of the phase and polarimetric images.

The polarization modulating mask may comprise chiral and/or non-chiral liquid crystals, each liquid crystal being characterized by its alignment.

The polarization modulating mask may be configured to allow the alignment or the position of the liquid crystals to be modified by applying an external voltage, a local and/or a global temperature change, and/or any non-linear optical process.

The polarization modulating mask may be chosen among the group made of a polarization modulating diffuser like a thin layer of white paint, a liquid-crystal thin film, with liquid crystals orientations tailored according to a periodic lattice of a unit cell, a liquid-crystal thin film, with liquid crystals orientations having random organization, potentially exhibiting topological dislocations, a liquid crystal thin film with electro-optical control to tune the device performances, a birefringent poly-crystalline structure, a meta-surface made of metallic or dielectric nano-structures, and an array of polarization sensitive diffraction gratings with various orientations.

The polarization modulating mask may be made of metamaterials. Alternatively, it may be made of any birefringent material, like liquid crystal cells, which maximize the modulation rate of the incident beam.

Preferentially, the polarization modulating mask has a transmission coefficient larger than 0.95 and diffracts at least 30% of an unpolarized impinging beam. The fraction of undiffracted light may then be less than 70% of the transmitted beam. The fraction of undiffracted light may be measured experimentally by sending a set of four impinging beam representing a basis of all polarization states, for instance linear 0°, 45°, 90° and right-handed circular, and by measuring in each case the fraction of light energy at the focal point of a lens. For a fully polarized incident beam, the output beam has preferentially a polarization rate as close to 1 as possible. The polarization rate of the output beam depends on the ratio of the spectral correlation width of the mask on the one hand, and the spectral width of the input beam, on the other hand.

Structured or random assembly of liquid crystal or protein crystal, for instance, makes the fabrication process of the mask well controlled. The advantage of dense crystalline structures and liquid crystal structures is that the fraction of phase and polarization unmodulated light can easily be made very small, contrary to metasurfaces based on resonant nanostructures. Moreover, resonant nanostructures are known to exhibit important spectral dependence.

The polarization modulating mask may be non-achromatic, the spectral width of the light beam being preferentially smaller than the spectral correlation width of the transmission matrix of the mask.

The polarization modulating mask may be a dynamic polarization and/or phase shifter, for example based on an acousto-optical device, a scanning mirror, a spatial light modulator, or a piezo-electric device.

### Incident Light Beam

The incident light beam may be generated by a light source.

The method according to the invention is compatible with temporally low-coherence light sources. The method may not require active illumination nor active detection.

The incident light beam may have a partial polarization coherence.

The incident light beam may have a large enough spatial coherence width. The system performs better for impinging beam exhibiting typical spatial coherence width larger than the typical size of the mask structures w. This means that over one single structure width area w² of the mask, the incident beam may be characterized by one single wavefront gradient vector and one single polarization state.

The method may be working over the entire visible domain, where the camera sensor is the most efficient.

When considering broadband light beams, the wavelength to be considered is the average wavelength, measured over the spectrum of the light beam:

$${λ}_{average} = \frac{\int λ s ( λ ) d λ}{\int s ( λ ) d λ} ,$$

where s(λ) is the power spectrum density of the impinging signal light beam.

The polarization and wavefront shape imaging system may comprise a polarizer downstream from the light source to linearly polarize the incident light beam. The system may comprise a quarter waveplate downstream from the polarizer to circularly polarize the incident light beam.

### Method

At step (A) of the method, the recording of the set of at least four reference intensity patterns may be achieved by using spatially coherent light in combination with a polarization state generator. The polarization state generator may be composed of polarization optics and/or electro-optics such as polarizers, retarding waveplates and liquid-crystal retarding plates controlled by external voltage.

The set of reference intensity patterns may comprise N reference intensity patterns (Rₚ)_{p∈[1:N]}, N being larger than or equal to 4.

The step (C) may comprise:
(C.1) computing polarization weights data A=(αₚ)_{p∈[1:N]} and deformation data (sₚ) of each given reference intensity pattern, for the single intensity image, by running a reconstruction algorithm, minimizing the difference between

$${I}_{s e n s o r} ( {r}_{j} ) and {\sum }_{p = 1}^{N} {α}_{p} ( {r}_{j} ) {R}_{p} ( {r}_{j} + {s}_{p , j} ) , j$$

being a given camera pixel of the intensity sensor camera, rⱼ being said pixel coordinate at the camera sensing plane, Fₚ being the reference pattern of polarization state p, sₚ being a deformation data representing the amount of relative displacement of the pattern Fₚ, sₚ being proportional to the wavefront gradient of the fraction of signal light beam having polarization state p, the polarization weights data αₚ(r) and deformation data sₚ being representative of a polarization state and a diffeomorphism, respectively, and
(C.2) calculating the Stokes parameters and the spatial phase of the incident light beam from the polarization weights data (αₚ) and deformation data (sₚ).

The minimization between

$${I}_{sensor} ( {r}_{j} ) and {\sum }_{p = 1}^{N} {α}_{p} ( {r}_{j} ) {R}_{p} ( {r}_{j} + {s}_{p , j} )$$

may be achieved considering subsets of pixels, called macropixels, assuming that both αₚ(rⱼ) and s_{p,j} are constant over each macropixel. For instance, one set of value α_{p,k} and s_{p,k} assumed to be constant over a macropixel k may be obtained by considering minimizing the norm 2 difference Lₖ:

$${L}_{k} = {\sum }_{j} W ( {r}_{j} ) {\vert {I}_{sensor} ( {r}_{j} ) - {\sum }_{p = 1}^{4} {α}_{p , k} {R}_{p} ( {r}_{j} + {s}_{p , k} ) \vert}^{2}$$

where the summation is achieved for j running over all pixels of macropixel k and where W(rⱼ) may be any weighting function.

This minimization may be achieved using gradient descent algorithms, pseudo-inversion, thresholded inversion by singular value decomposition, convolutional neuronal networks. Alternatively, the minimization between Iₛₑₙₛₒᵣ(rⱼ) and

$${\sum }_{p = 1}^{N} {α}_{p} ( {r}_{j} ) {R}_{p} ( {r}_{j} + {s}_{p , j} )$$

may be achieved using any other norm than the norm 2.

The deformation data s_{p,k} describes a diffeomorphism of the intensity patterns, i.e. the distortion experienced by the reference intensity patterns under wavefront deformation of the corresponding reference light beams.

The N reference intensity patterns may have been generated by N respective impinging reference light beams.

The N reference impinging beams are preferentially evenly distributed over the so-called polarization Poincaré sphere. In polarimetry, the measurement accuracy is proportional to the volume in the Poincaré sphere enclosed by the simplex whose corners are the reference polarizations. Hence, the four reference impinging beams are preferentially the corners of a regular tetrahedron.

The N reference beams may be only partially polarized, in which case the aforementioned requirement about the N reference beams applies to their polarized components.

N may be equal to four. The four impinging beams may have respective polarizations linear 0°, linear 45°, linear 90° and circular right-handed. An alternative may consist in four impinging beams having respective polarizations: linear 0°, linear 45°, circular right-handed and circular left-handed.

For optimal reconstruction, a set of six impinging reference light beams may be used of respective polarizations: linear 0°, linear 45°, linear 90°, linear −45°, circular right-handed and circular left-handed.

The wavefront shape φₚ associated with polarization state p may be rebuilt thanks to a two-dimensional integration of the vector fields

$$\vec{∇ {φ}_{p}} = \frac{2 π}{d {λ}_{average}} \vec{{s}_{p}} ,$$

as described in EP20305898, wherein sₚ is the deformation data expressed as a displacement amount at the camera plane, d is the working distance between the polarization modulating mask, or its image, and the single intensity image Iₛₑₙₛₒᵣ of the impinging light beam, and λ_{average} is the average wavelength of the impinging light beam.

N reference intensity patterns R=(Rₚ)_{p∈[1:N]}, N being larger than or equal to 4, may be generated by N respective impinging reference light beams having any N known polarization states defining all together a polyhedron of non-zero volume when represented on the polarization Poincaré sphere, the polarization state of the N impinging reference light beams having known respective Stokes vector representations SR=(SRₚ)_{p∈[1:N]}, the step (C.2) comprising:
(C.2.1) Computing a measurement matrix W relating the Stokes vector representation of the impinging reference light beams to their corresponding reference intensity patterns according to the matrix equation: R=W×SR, and (C.2.2) computing a Stokes parameter vector image S of the incident light beam from the single intensity image Iₛₑₙₛₒᵣ by inverting the matrix equation Iₛₑₙₛₒᵣ=W×S or from the polarization weight data A=(αₚ)_{p∈[1:N]} by inverting the matrix equation: R×A=W×S.

### N=4

The four impinging reference light beams may have flat wavefronts, and polarization states represented respectively in the Cartesian coordinates basis by the Jones vectors V₁=

$$[ \begin{matrix}1 \\ 0\end{matrix} ] , {V}_{2} = [ \begin{matrix}0 \\ 1\end{matrix} ] , {V}_{3} = \frac{1}{\sqrt{2}} [ \begin{matrix}1 \\ 1\end{matrix} ] and {V}_{4} = \frac{1}{\sqrt{2}} [ \begin{matrix}1 \\ i\end{matrix} ] ,$$

having respective Stokes vector representations

$${SF}_{1} = ( \begin{matrix}1 \\ 1 \\ 0 \\ 0\end{matrix} ) , {SF}_{2} = ( \begin{matrix}1 \\ - 1 \\ 0 \\ 0\end{matrix} ) , {SF}_{3} = ( \begin{matrix}1 \\ 0 \\ 1 \\ 0\end{matrix} ) , {SF}_{4} = ( \begin{matrix}1 \\ 0 \\ 0 \\ 1\end{matrix} ) ,$$

generating respective reference intensity patterns R₁, R₂, R₃, and R₄, the step (C.2.2) comprising: calculating the Stokes parameters S₀, S₁, S₂ and S₃ of the incident light beam using the equations: S₀=α₁+α₂, S₁=α₁−α₂, S₂=α₃ and S₃=α₄.

The polarization modulating mask may have the property to generate several sets of four reference intensity patterns at respective several working distances from the polarization modulating mask, when illuminated by four respective impinging reference light beams, one set of four reference intensity patterns per working distance.

The four impinging reference light beams may have polarization states defining all together a tetrahedron of non-zero volume when represented on the polarization Poincaré sphere, and each said set of four reference intensity patterns may form a Stokes parameters image basis, meaning that the auto-correlation matrix C_{L} of the corresponding four reference intensity patterns is invertible. This allows the working distance d to be changed to improve sensitivity to weak wavefront deformations, and/or to improve spatial resolution, and/or to maximize the orthogonality of the four reference intensity patterns, for instance by maximizing the minimum eigen-value of an auto-correlation matrix C_{L} involving all reference intensity patterns.

Shorter distances d may yield better spatial resolution. Large distances d may improve sensitivity to small wavefront distortions.

The polarization modulating mask may have the patterns generated at the working distance d, each with their respective two gradient component patterns, defining together a basis of 12 patterns, meaning that the 12×12 elements auto-correlation matrix C_{L}=( [symbol] Fᵢ|Fⱼ [symbol] _{L,G} [symbol] constructed over at least one macropixel from both the reference intensity patterns and their respective intensity gradient maps be invertible, in order to ensure that the wavefront shapes of the incident light beam may be computed in addition to its polarization state and polarization rate.

The 12×12 elements auto-correlation matrix CL may be defined as:

$${C}_{L} = {( 〈 {F}_{i} \vert {F}_{j} 〉 )}_{( i , j ) ∈ 〚 1 , 12 〛} = {[ \overline{( {F}_{i} - \overline{{F}_{i}} ) ( {F}_{j} - \overline{{F}_{j}} )} ]}_{( i , j ) ∈ 〚 1 , 4 〛} \\ with \begin{matrix}{F}_{1} = {R}_{1} & {F}_{2} = {R}_{2} & {F}_{3} = {R}_{3} & {F}_{4} = {R}_{4} \\ {F}_{5} = {\partial }_{x} {R}_{1} & {F}_{6} = {\partial }_{x} {R}_{2} & {F}_{7} = {\partial }_{x} {R}_{3} & {F}_{8} = {\partial }_{x} {R}_{4} \\ {F}_{9} = {\partial }_{y} {R}_{1} & {F}_{10} = {\partial }_{y} {R}_{2} & {F}_{11} = {\partial }_{y} {R}_{3} & {F}_{12} = {\partial }_{y} {R}_{4}\end{matrix}$$

and where R₁, R₂, R₃ and R₄ are the four reference intensity patterns.

Considering this auto-correlation matrix may be advantageous in the case of small enough wavefront gradients inducing intensity patterns displacement typically smaller than w.

In the case where R₁ and R₂ are obtained for two orthogonally polarized impinging reference light beams, one may also alternatively consider for F₁, F₂, F₃ and F₄:

$$\begin{matrix}{F}_{1} = {R}_{1} & {F}_{2} = {R}_{2} & {F}_{3} = R ( z ) & {F}_{4} = I ( z ) \\ {F}_{5} = {\partial }_{x} {R}_{1} & {F}_{6} = {\partial }_{x} {R}_{2} & {F}_{7} = {\partial }_{x} R ( z ) & {F}_{8} = {\partial }_{x} I ( z ) \\ {F}_{9} = {\partial }_{y} {R}_{1} & {F}_{10} = {\partial }_{y} {R}_{2} & {F}_{11} = {\partial }_{y} R ( z ) & {F}_{12} = {\partial }_{y} I ( z )\end{matrix} \\ with : R ( z ) = {R}_{3} - \frac{1}{2} ( {R}_{1} + {R}_{2} ) and I ( z ) = {R}_{4} - \frac{1}{2} ( {R}_{1} + {R}_{2} ) .$$

The orthogonality of this alternative set of patterns Rᵢ, R₂, R₃ and R₄ is equivalent to the former one. However, the eigen-values of C_{L} obtained in either cases may be different and may suggest different optimized working points.

Having the 12×12 auto-correlation matrix being invertible ensures that the global auto-correlation matrix C_{G}=( [symbol] Rᵢ|Rⱼ [symbol] _{G} [symbol] is also invertible in the particular case of small enough wavefront gradients yielding small enough displacements of intensity patterns at the camera.

### Optimization Polarization Modulating Mask

An efficient criterion to ensure phase imaging capability may be to optimize the polarization modulating mask so that the auto-correlation matrix made of both the reference intensity patterns and their respective gradient maps be invertible. This auto-correlation matrix is invertible if and only if its determinant is not zero.

The determinant of this 12×12 auto-correlation matrix may be maximized to ensure optimal retrieval of the four Stokes vector components together with their related local wavevector, having two spatial components each. Maximizing the determinant is equivalent to maximizing the ratio between the smallest eigenvalue and the largest eigenvalue of the auto-correlation matrix. Such an optimization may be done using a genetic algorithm.

The unit cell of the polarization modulating mask may be optimized using the following algorithm:
i. recording or computing numerically four reference intensity patterns R₁, R₂, R₃, and R₄ with the polarization and imaging system, each reference intensity pattern being generated by a respective impinging light beam, the four impinging reference light beams having normalised intensity and four known polarization states defining a non-zero volume in the Poincaré sphere,
ii. Calculating the auto-correlation matrix C_{L}=( [symbol] Rᵢ|Rⱼ [symbol] _{L,G} [symbol] , where Rₚ are the reference intensity patterns recorded for the reference intensity light beam, and
iii. if C_{L} is not invertible or if the ratio of eigen-values eₘᵢₙ/eₘₐₓ of C_{L} is smaller than 1.5% or 1%, wherein eₘᵢₙ and eₘₐₓ are respectively the smallest and the largest eigen-values of the auto-correlation matrix C_{L}, modifying the unit cell of the polarized-resolved matrix of the polarization modulating mask and repeating steps i. and ii.

The previous algorithm may be comprised in an additional step of the method that is performed before step (A).

Alternatively, the unit cell of the polarization modulating mask may be optimized using the following algorithm:
i. recording or computing numerically four reference intensity patterns R₁, R₂, R₃, and R₄ with the polarization and wavefront shape imaging system, each reference intensity pattern being generated by a respective impinging light beam, the four impinging reference light beams having flat wavefronts, normalised intensity and four known polarization states defining a non-zero volume in the Poincaré sphere,
ii. Calculating the matrix C_{L}=( [symbol] (Fᵢ|Fⱼ [symbol] _{L,G} [symbol] , C_{L}=( [symbol] Fᵢ|Fⱼ [symbol] _{L,G} [symbol] being the auto-correlation matrix constructed from both the reference intensity patterns and their respective gradients,

$$with : \begin{matrix}{F}_{1} = {R}_{1} & {F}_{2} = {R}_{2} & {F}_{3} = {R}_{3} & {F}_{4} = {R}_{4} \\ {F}_{5} = {\partial }_{x} {R}_{1} & {F}_{6} = {\partial }_{x} {R}_{2} & {F}_{7} = {\partial }_{x} {R}_{3} & {F}_{8} = {\partial }_{x} {R}_{4} , \\ {F}_{9} = {\partial }_{y} {R}_{1} & {F}_{10} = {\partial }_{y} {R}_{2} & {F}_{11} = {\partial }_{y} {R}_{3} & {F}_{12} = {\partial }_{y} {R}_{4} ,\end{matrix}$$

and
iii. if C_{L} is not invertible or if the ratio of eigen-values eₘᵢₙ/eₘₐₓ of C_{L} is smaller than 1.5% or 1%, wherein eₘᵢₙ and eₘₐₓ are respectively the smallest and the largest eigen-values of the auto-correlation matrix C_{L}, modifying the unit cell of the polarized-resolved matrix of the polarization modulating mask and repeating steps i. and ii.

The previous algorithm may be comprised in an additional step of the method that is performed before step (A).

The polarization modulating mask may be optimized using the following algorithm:
i. Recording four reference intensity patterns R₁, R₂, R₃, and R₄ with the polarization and wavefront shape imaging system, each reference intensity pattern being generated by a respective impinging light beam, the four impinging reference light beams having flat wavefronts, normalised intensity and known polarization states represented respectively in the Cartesian coordinates basis by the Jones vectors

$${V}_{1} = [ \begin{matrix}1 \\ 0\end{matrix} ] , {V}_{2} = [ \begin{matrix}0 \\ 1\end{matrix} ] , {V}_{3} = \frac{1}{\sqrt{2}} [ \begin{matrix}1 \\ 1\end{matrix} ] and {V}_{4} = \frac{1}{\sqrt{2}} [ \begin{matrix}1 \\ i\end{matrix} ] ,$$

or equivalently, corresponding to the Stokes vectors

$${SF}_{1} = ( \begin{matrix}1 \\ 1 \\ 0 \\ 0\end{matrix} ) , {SF}_{2} = ( \begin{matrix}1 \\ - 1 \\ 0 \\ 0\end{matrix} ) , {SF}_{3} = ( \begin{matrix}1 \\ 0 \\ 1 \\ 0\end{matrix} ) , {SF}_{4} = ( \begin{matrix}1 \\ 0 \\ 0 \\ 1\end{matrix} ) ,$$

and
ii. Calculating the matrix C_{L}=( [symbol] Fᵢ|Fⱼ [symbol] _{L,G} [symbol] , C_{L}=( [symbol] Fᵢ|Fⱼ [symbol] _{L,G} [symbol] being the auto-correlation matrix constructed from both the reference intensity patterns and their respective gradients, with:

$$\begin{matrix}{F}_{1} = {R}_{1} & {F}_{2} = {R}_{2} & {F}_{3} = R ( z ) & {F}_{4} = I ( z ) \\ {F}_{5} = {\partial }_{x} {R}_{1} & {F}_{6} = {\partial }_{x} {R}_{2} & {F}_{7} = {\partial }_{x} R ( z ) & {F}_{8} = {\partial }_{x} I ( z ) , \\ {F}_{9} = {\partial }_{y} {R}_{1} & {F}_{10} = {\partial }_{y} {R}_{2} & {F}_{11} = {\partial }_{y} R ( z ) & {F}_{12} = {\partial }_{y} I ( z )\end{matrix}$$

with:

$${R}_{1} = {\vert {P}_{d} ( {TV}_{1} ) \vert}^{2} , {R}_{2} = {\vert {P}_{d} ( {TV}_{2} ) \vert}^{2} , R ( z ) = {R}_{3} - \frac{1}{2} ( {R}_{1} + {R}_{2} ) , \\ I ( z ) = {R}_{4} - \frac{1}{2} ( {R}_{1} + {R}_{2} ) , {R}_{3} = {\vert {P}_{d} ( {TV}_{3} ) \vert}^{2} ∧ {R}_{4} = {\vert {P}_{d} ( {TV}_{4} ) \vert}^{2} ,$$

where |P_{d}(TVₚ)|² is the reference intensity pattern recorded for the reference intensity light beam of vector Vₚ, P_{d} being a free space propagation function and T being the polarized-resolved transmission or reflection matrix of the polarization modulating mask
iii. Modifying the polarized-resolved matrix of the polarization modulating mask and repeating steps i. and ii., if C_{L} is not invertible or if the ratio of eigen-values eₘᵢₙ/eₘₐₓ of CL is smaller than 1.5% or 1%.

### Interferometers

The polarization and wavefront shape imaging system may comprise an interferometer upstream of the intensity sensor camera.

The interferometer may be chosen among the following list of known interferometers: Linnik interferometer, Mach-Zehnder interferometer, Fabry-Perot interferometer.

The polarization modulating mask may be inside the interferometer. By “inside the interferometer” it must be understood that at least a part of the light beam entering the interferometer is reflected by or transmitted through the polarization modulating mask before exiting the interferometer.

The interferometer may comprise a set of lenses allowing to image the polarization modulating mask at a distance d to the intensity sensor camera equal to zero and to potentially increase the spatial resolution of the polarization images and/or wavefront shapes images.

The interferometer may comprise two optical paths.

The polarization modulating mask may be located on one of the two optical paths of the interferometer to induce a global phase shifting.

The incident light beam to be characterized may be generated inside the interferometer, for instance by reflection or transmission of an illuminating beam onto/through a sample, a mirror or even nothing.

In particular, the reference intensity patterns and the signal intensity pattern allowing the measurement of polarization and preferentially wavefront shapes data, may be recorded by the intensity sensor camera by creating an interference between two parts of the incident light beam propagating respectively on the two optical paths of the interferometer.

Several intensity images of the signal light beam may be recorded with the intensity sensor camera, the several intensity images being notably recorded after inducing a phase and/or a polarization shift to at least one of the two arms of the interferometer by using a dynamic device, for instance by moving one of the mirrors of the interferometer by a slight amount, in particular over one wavelength, using a piezo-electric translation stage.

### Imaging System

A further subject of the invention, according to another of the aspects thereof, is a polarization and wavefront shape imaging system for generating data related at least to the polarization state and the polarization rate, and advantageously to the wavefront shapes, of an incident light beam of any polarization state and any polarization rate, from a single intensity image acquisition Iₛₑₙₛₒᵣ of said light beam, which comprises:
a polarization modulating mask being a diffractive optical element, notably as defined above, having:
   a polarization-resolved transmission or reflection matrix T, and
      the property to generate interference patterns between any two cross-polarized impinging beams, at several planes transverse to the propagation axis, the several transverse planes lying at several working distances from said polarization modulating mask, the interference patterns so depending on the two respective amplitudes and the relative phase of said two cross-polarized impinging beams, and
   the property to generate at least one set of four reference intensity patterns, at least at one working distance from the polarization modulation mask, when illuminated by four respective impinging reference light beams, one set of four reference intensity patterns per working distance, the four impinging reference light beams having polarization states defining all together a tetrahedron of non-zero volume when represented on the polarization Poincaré sphere, and each said set of four reference intensity patterns forming a Stokes parameters image basis, meaning that the auto-correlation matrix C_{L}=( [symbol] Rᵢ|Rⱼ [symbol] _{L,G} [symbol] of the corresponding four reference intensity patterns is invertible, Ri being the reference pattern of polarization state i,
an intensity sensor camera being placed downstream from said polarization modulating mask for recording an intensity image of the incident light beam, at least a part of which having preferentially been reflected by or transmitted through the polarization modulating mask, or alternatively at least a part of the incident light beam having preferentially interfering with another beam reflected by or transmitted through the polarization modulating mask, said intensity image lying at any of the several of said working distances from the polarization modulating mask,
storage and computing means for:
(a) preferentially recording one set of at least four reference intensity patterns with the intensity sensor camera of the imaging system, the reference intensity patterns being formed at one given of said working distances d, from the polarization modulating mask, each reference intensity pattern having been generated by a respective impinging reference light beam of known non-zero polarization rate, known polarization state, and advantageously of known wavefront shape, the polarization states of the impinging reference light beams defining all together a polyhedron of non-zero volume when represented on the polarization Poincaré sphere and reference intensity patterns defining a Stokes parameters image basis at the working distance d, thus allowing the determination of the full polarization state of the impinging light beam,
(b) recording the single intensity image Iₛₑₙₛₒᵣ of said incident light beam with the intensity camera sensor, the single intensity image being formed at the same given working distance d from the polarization modulating mask,
(c) processing the single intensity image based on the reference intensity patterns to generate the data related to the polarization state and the polarization rate, and advantageously to the wavefront shapes of the impinging light beam.

The storage and computing means may be chosen among the list: a personal computer potentially equipped with a graphic card, a cell phone, a field-programmable gate array, a microcontroller, or a programmable logic device.

The intensity sensor camera may comprise a pixilated surface, at least one subset of four reference intensity patterns among the at least four reference intensity patterns having the property to generate an invertible auto-correlation matrix C_{L}, and the auto-correlation matrix may be computed over at least one macropixel containing less than 20×20 camera pixels, better less than 12×12 camera pixels, better less than 6×6 camera pixels.

The set of reference intensity patterns may comprise N reference intensity patterns (Rₚ)_{p∈[1:N]}, N being larger than or equal to 4. The storage and computing means may be configured for, in the step (c):
(c.1) computing polarization weights data A=(αₚ)_{p∈[1:n]} and deformation data (sₚ) of each given reference intensity pattern, for the single intensity image, by running a reconstruction algorithm minimizing the difference between Iₛₑₙₛₒᵣ(rⱼ) and

$${\sum }_{p = 1}^{n} {α}_{p} ( {r}_{j} ) {R}_{p} ( {r}_{j} + {s}_{p , j} ) ,$$

j being a camera pixel of the intensity sensor camera, rⱼ being said pixel coordinate at the camera sensing plane, Rₚ being the reference pattern of polarization state p, sₚ being a deformation data representing the amount of relative displacement of the pattern Rₚ, sₚ being proportional to the wavefront gradient of the fraction of signal light beam having polarization state p, the polarization weights data αₚ(r) and deformation data sₚ being representative of a polarization state and a diffeomorphism, respectively, and
(c.2) calculating the Stokes parameters and the spatial phase of the incident light beam from the polarization weights data (αₚ) and deformation data (sₚ).

The polarization modulating mask may comprise a two-dimensional diffraction grating consisting in a periodic lattice of at least one period and based on an unit cell, for instance a two-dimensional periodic lattice, in particular the unit cell is a square cell, in particular each unit cell comprising four square adjacent polarization modulating domains arranged in rows and columns.

The polarization modulating mask may comprise a plurality of polarization modulating domains, each polarization modulating domain having preferably a uniform polarization-resolved matrix over said polarization modulating domain, the polarization modulating domains being for instance randomly arranged or periodically arranged in a lattice in the polarization modulating mask.

Each unit cell may comprise four adjacent polarization modulating domains arranged in rows and columns, the four adjacent polarization modulating domains having preferentially a linear retardance of π/2±π/4 rad and relative fast axes orientations rotating by {+π/3+π/3 −π/3 −π/3} radians, or equivalently absolute fast axes orientation of {α; α+π/3; α+2π/3; α+π/3}, when running around the four adjacent domains clockwise or counter clockwise, a being an angle and the tolerance on fast-axes orientations being ±π/6 rad.

The polarization modulating mask may comprise chiral and/or non-chiral liquid crystals, each liquid crystal being characterized by its alignment.

The polarization modulating mask may comprise a nanostructured metamaterial.

The polarization modulating mask may be placed in the close vicinity of the chip of the intensity camera sensor or, alternatively, it may be imaged in a plane close to the camera using a plurality of lenses and/or mirror.

### Mask

Another subject of the invention, according to another of the aspects thereof, is a polarization modulating mask comprising a diffraction grating consisting in a periodic two-dimensional lattice based on a unit cell comprising a plurality of polarization modulating domains, the unit cell comprising four square adjacent polarization modulating domains arranged in rows and columns, the four adjacent polarization modulating domains having a linear retardance of π/2±7π/4 rad and their relative fast axes orientations rotate by {+π/3+π/3 −π/3−π/3} radians, or equivalently absolute fast axes orientation of {α; α+π/3; α+2/3; α +π/3}, when running around the four adjacent domains clockwise or counter clockwise, α being an angle and the tolerance on fast-axes orientations being ±π/6 rad.

### Use of the System

Another subject of the invention, according to another of the aspects thereof, is a use of the system described above, for at least one of the following applications: polarization imaging, phase imaging, fluorescence imaging, super-resolution fluorescence microscopy, back-scattering imaging, to record phase and/or polarimetric images of a sample, so providing information about the molecular and/or structural organization of the sample.

### Method for Generating Data Related at Least to the Polarization State and the Polarization Rate

According to another of its aspects, the invention relates to a method for generating data related at least to the polarization state and the polarization rate, and advantageously to the wavefront shapes, of an incident light beam of any polarization state and any polarization rate, from a single intensity image acquisition Iₛₑₙₛₒᵣ of said light beam, using a polarization and wavefront shape imaging system which comprises a polarization modulating mask and an intensity sensor camera:
the polarization modulating mask being a diffractive optical element having:
   a polarization-resolved transmission or reflection matrix T,
      the property to generate interference patterns between any two cross-polarized impinging beams, at several planes transverse to the propagation axis, the several transverse planes lying at several working distances from said polarization modulating mask, the interference patterns so depending on the two respective amplitudes and the relative phase of said two cross-polarized impinging beams, and
   the property to generate at least one set of four reference intensity patterns, at least at one working distance (d) from the polarization modulation mask, when illuminated by four respective impinging reference light beams, the four impinging reference light beams having polarization states defining all together a tetrahedron of non-zero volume when represented on the polarization Poincaré sphere,
   each said set of four reference intensity patterns forming a Stokes parameters image basis, meaning that the auto-correlation matrix C_{L}=( [symbol] Rᵢ|Rⱼ [symbol] _{L,G} [symbol] of the corresponding four reference intensity patterns is invertible,
Rᵢ being the reference intensity pattern of polarization state i,
the intensity sensor camera being placed downstream from said polarization modulating mask for recording the intensity image Iₛₑₙₛₒᵣ of the incident light beam, at least a part of which having preferentially been reflected by or transmitted through the polarization modulating mask, or alternatively at least a part of the incident light beam having interfering with another beam reflected by or transmitted through the polarization modulating mask, said intensity image lying at any of the several of said working distances from the polarization modulating mask,
   the method comprising, when the polarization modulating mask is known by design and potentially included in a interferometer:
(A′) recording the single intensity image Iₛₑₙₛₒᵣ of said incident light beam with the intensity sensor camera, the single intensity image being formed at the same given working distance from the polarization modulating mask,
(B′) processing the single intensity image Iₛₑₙₛₒᵣ based on the design of the polarization modulating mask to generate the data related to the polarization state and the polarization rate, and advantageously to the wavefront shapes of the impinging light beam.

### BRIEF DESCRIPTION OF THE FIGURES

The accompanying drawings, which are incorporated in and constitute a part of the specification, illustrate presently preferred embodiments of the invention, and together with the description, serve to explain the principles of the invention. In the drawings:

FIG. 1 is schematic view of a first example of a polarization and wavefront shape imaging system made in accordance with the invention,

FIG. 2a is an illustration of a first example of birefringent motif that can be used as a unit cell for a periodic-lattice polarization modulating mask made in accordance with the invention,

FIG. 2b is a graphic showing the functioning points of a polarization and wavefront shape imaging system made in accordance with the invention with the polarization modulating mask of FIG. 2a,

FIG. 2c is an illustration of a periodic-lattice polarization modulating mask made of an arrangement of the unit cell of FIG. 2a,

FIG. 2d is another illustration of the unit cell of FIG. 2a,

FIG. 2e is another illustration of the unit cell of FIG. 2a,

FIG. 3a is an illustration of a second example of birefringent motif that can be used as a unit cell for a periodic-lattice polarization modulating mask made in accordance with the invention,

FIG. 3b is an illustration of a liquid-crystal polarization modulating mask lattice made of a periodic arrangement of the unit cell of FIG. 3a,

FIG. 3c is a graphic showing the functioning points of a polarization and wavefront shape imaging system made in accordance with the invention with the polarization modulating mask of FIG. 3b,

FIG. 4 is a graphic showing the functioning points of a polarization and wavefront shape imaging system made in accordance with the invention with a random polarization modulating mask,

FIG. 5 is diagram of the principle of the polarized wavefront sensing made in accordance with the invention,

FIG. 6a is a diagram of the workflow of a reconstruction algorithm made in accordance with the invention,

FIG. 6b is a diagram of the workflow of another reconstruction algorithm made in accordance with the invention,

FIG. 6c is a diagram of the workflow of the algorithm used for demultiplexed registration in FIG. 6b,

FIG. 7 shows simulations results obtained with the polarization modulating mask made in accordance with the invention,

FIG. 8 shows experimental results obtained with a liquid crystal Q-plates with a thin layer of white paint as a polarization modulating mask,

FIG. 9a is schematic view of a first example of a polarization and wavefront shape imaging system made in accordance with the invention and comprising a Linnik interferometer,

FIG. 9b is schematic view of a second example of a polarization and wavefront shape imaging system made in accordance with the invention and comprising a Linnik interferometer,

FIG. 9c is schematic view of a first example of a polarization and wavefront shape imaging system made in accordance with the invention and comprising a Mach-Zehnder interferometer,

FIG. 9d is schematic view of a second example of a polarization and wavefront shape imaging system made in accordance with the invention and comprising a Mach-Zehnder interferometer,

FIG. 9e is schematic view of an example of a polarization and wavefront shape imaging system made in accordance with the invention and comprising a Fabry-Perot interferometer.

### DETAILED DESCRIPTION OF THE FIGURES

### System

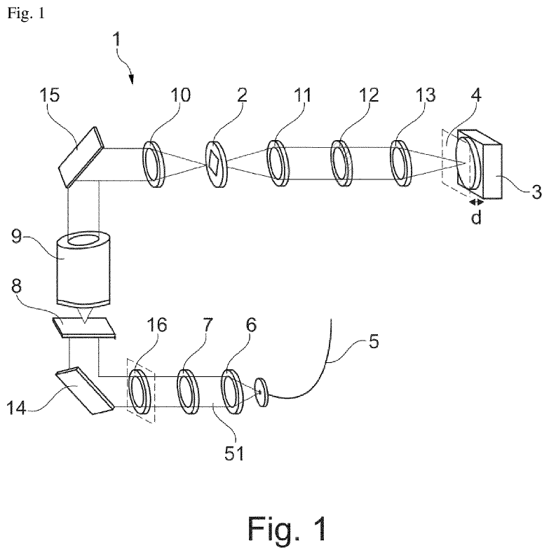

FIG. 1 shows a polarization and wavefront shape imaging system 1 comprising a polarization modulating mask 2 imaged at a short distance d from an intensity camera sensor 3. The system 1 comprises a fiber 5 connected to a laser source, that sends a beam light 51 through a collimation lens 6. The collimated beam light passes through a polarizer 7 of the system 1, which allows to linearly polarize the light that is then sent to a sample 8 to analyse. The light diffracted by the sample 8 is directed through a microscope objective 9 and a tube lens 10, both comprised in the system 1, before being focalised on the mask 2. The polarization modulating mask 2 is imaged at a short distance d from the camera 3, in an image plane 4, thanks to a set of lenses 11 and 13 comprised in the system 1, for example arranged in an afocal telescope. In this case, the camera 3 can record either a real image plane, lying after the image plane 4 of the mask 2, but it can also record a “virtual image”, located in a virtual image plane lying before the image plane 4 of the mask 2. Some polarization modulating mask 2 can also be exactly imaged onto the camera 3.

The system 1 may comprise mirrors 14 and 15 to direct the light in a wanted direction. It may also comprise a Fourier filter set like a diaphragm 12 to adjust the aperture of the light beam 51 or select specific diffraction orders of the mask. A removable quarter waveplate 16 may also be comprised in the system after the polarizer 7 to circularly polarize the light.

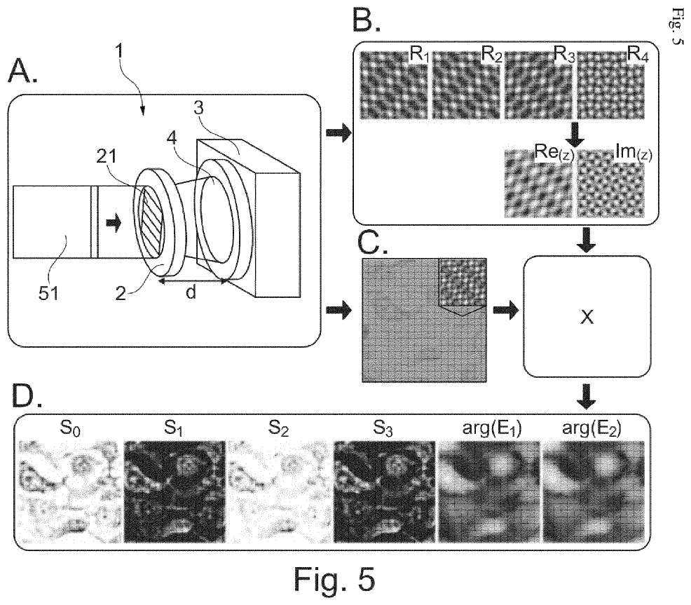

In an alternative configuration, the mask 2 is not re-imaged but directly placed at a short distance d from the camera 3, as shown in FIG. 5a, making the system especially compact.

The distance d between the mask 2, or its image 4, and the camera sensor 3 is a parameter that allows tuning the performances of the system. Tuning this distance d allows balancing the compromise between the wavefront sensitivity of the camera 3 on the one hand, and the spatial resolution on it. It also allows optimizing the orthogonality of intensity patterns obtained for different input polarizations.

The polarization modulating mask 2 may comprise a liquid crystal matrix 21, for example between two transparent glass covers. Liquid crystal can be aligned for instance thanks to a so-called alignment layer which may be created using a photo-sensitive aligning molecule, as described in Yaroshchuk, O. (2012). Photoalignment of liquid crystals: basics and current trends. Journal of Materials Chemistry, 2, that allows defining domains wherein the liquid crystals orientation will be uniform. The transparent covers may be made of any glass or using conductive glass such as Indium Tin Oxide (ITO). In this latter case a longitudinal electric field may be applied to the liquid crystal matrix to vary and tune the retardance of cells, potentially to optimize the performances of the mask.

The mask 2 may comprise cholesteric liquid crystals in which case each cell is associated to a circular retardance. At a fixed wavelength, the phase delay (linear and/or circular retardance) may be tuned by changing the thickness of the liquid crystal layer. For a fixed thickness, different wavelengths experience different phase delays. For such a geometry and non-cholesteric liquid crystals, an optimal linear retardance is close to π/2.

The liquid crystal matrix 21 may be two-dimensional periodic lattice comprising unit cells 210, as shown in FIGS. 1a, 1b, 1c, 2a, 2d, 2e, 3a and 3b. In this case, the polarization mask is a thin two-dimensional diffraction grating relying on the principle of the Pancharatnam-Berry geometric phase modulation, advantageously making the optical performances weakly sensitive to the wavelength and spectral width of the impinging beam. Noteworthy, any uniform rotation of the fast axes by an angle α in the mask shown in FIGS. 1a, 1b, 1c, 2a, 2d, 2e, 3a, 3b yields equivalent polarization imaging properties. A unit cell 210 is made of domains 211 wherein the orientation of liquid crystals axis in each domain 210 follows the one shown by the small rods in FIG. 1a, 1b, 1c, 2a, 2d, 3a and 3b.

If polarimetric imaging is wanted but wavefronts are not required by the application, then, the polarization-modulating mask can be specifically designed for polarimetric imaging only and the following arrangements can then be done: the distance d can then be set to zero and/or the mask can be specifically optimized for polarization-only imaging, and/or a Fourier filter 12 can be introduced to select the diffracting orders of interest of the grating. This arrangement allows the sensitivity and precision and/or the resolution of the polarization images to be improved as compared to the case where wavefronts are also required.

The advantage of setting d to zero may be to make the intensity at the camera insensitive to the impinging wavefronts, so making the polarization reconstruction algorithm simpler.

An illustration of some optimized polarization modulating masks consisting in birefringent two-dimensional polarization gratings allowing full-Stokes polarimetric imaging at a distance d=0 distance are shown in FIGS. 1a to 1c. The metric optimized for getting these masks is the determinant of the matrix to be inverted for polarization information reconstruction.

The grating illustrated in FIG. 1a and the grating shown in FIG. 1b work better when combined with an amplitude Fourier filter 12 selecting the undiffracted light together with the two main diffracted orders along two orthogonal directions. Alternatively, the grating shown in FIG. 1c does not require a Fourier filter.

Using any of these three masks illustrated in FIGS. 1a to 1c, the spatial resolution of the full-Stokes polarization images can be equal to 3×3 camera pixels per unit cell of the lattice grating.

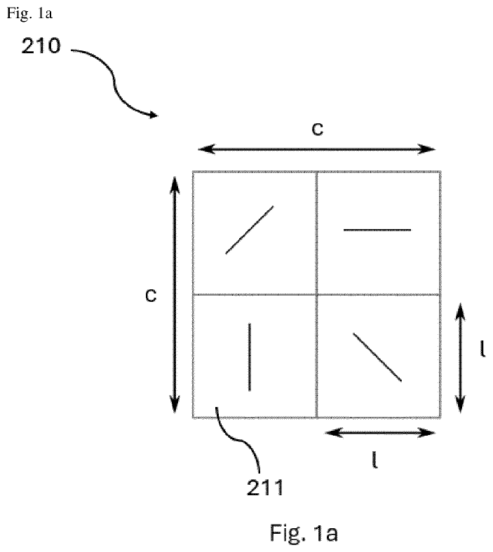

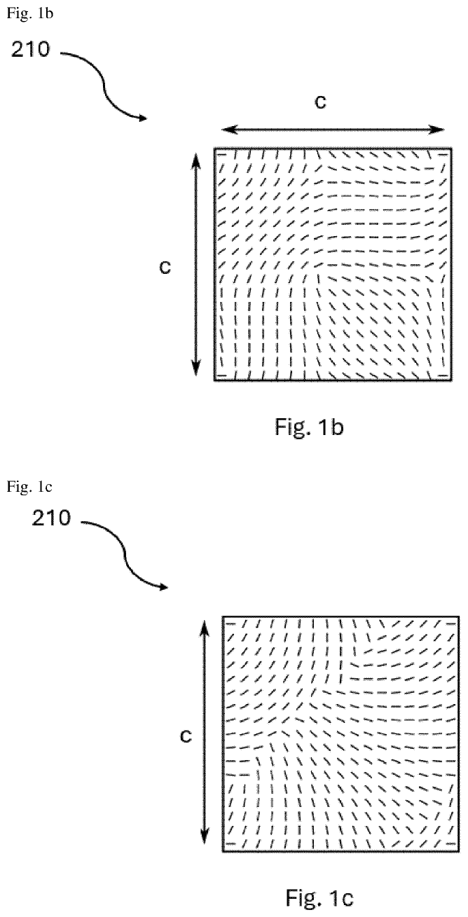

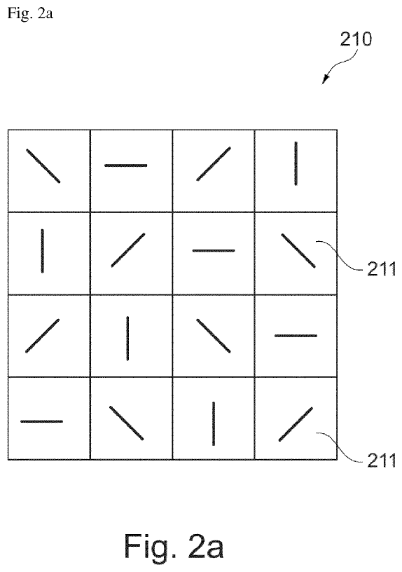

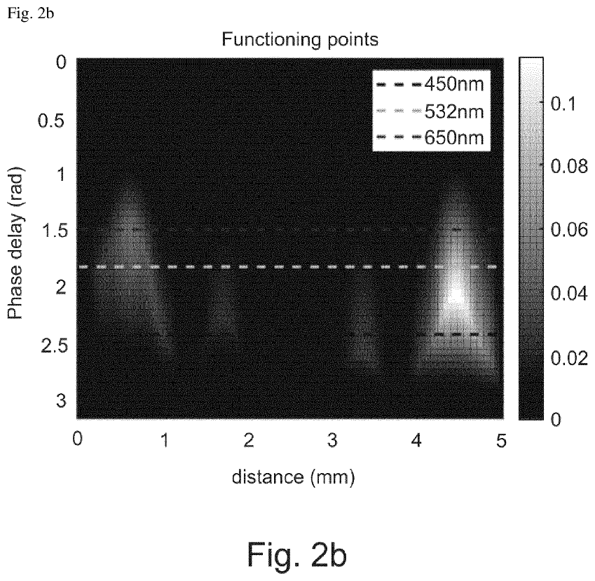

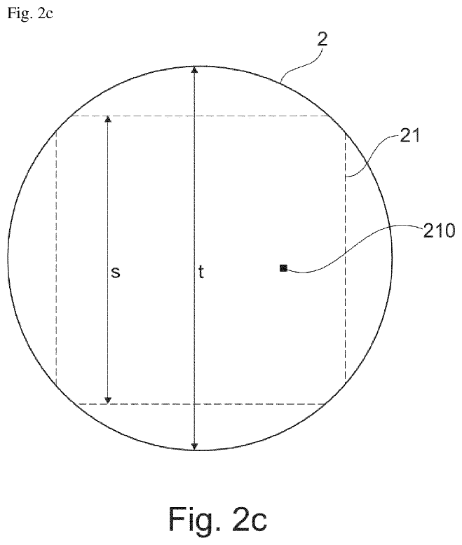

In FIG. 2a, the unit cell 210 is a square made of 4×4 square domains 211 all with the same retardance. The liquid crystals axis orientation alternatively rotates clockwise and counter-clockwise from one row or column to another, FIG. 2e displays the angle in degree of the fast axis of each birefringent domain 211.

The size c of the unit cell 210 is for instance 156 μm, and the size 1 of a domain 211 is for example 39 μm, as shown in FIG. 2d. The retardance of the domains 211 may be 160 nm at a wavelength of 632.8 nm. The mask 2 is for example a disk of diameter t equal to 5.08 cm and the liquid crystal matrix may be a square of size s equal to 3.81 cm.

In the examples of FIGS. 1a to 1c, the size c of the unit cell 210 is 60 μm.

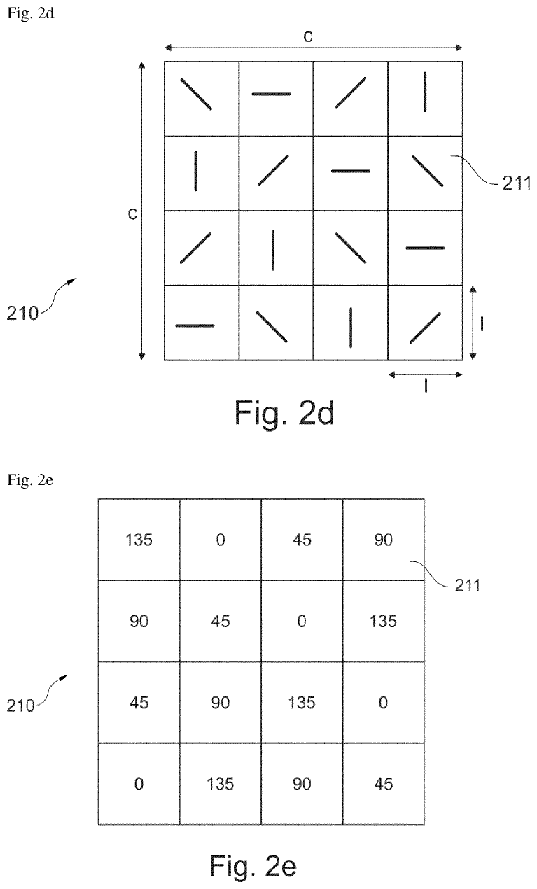

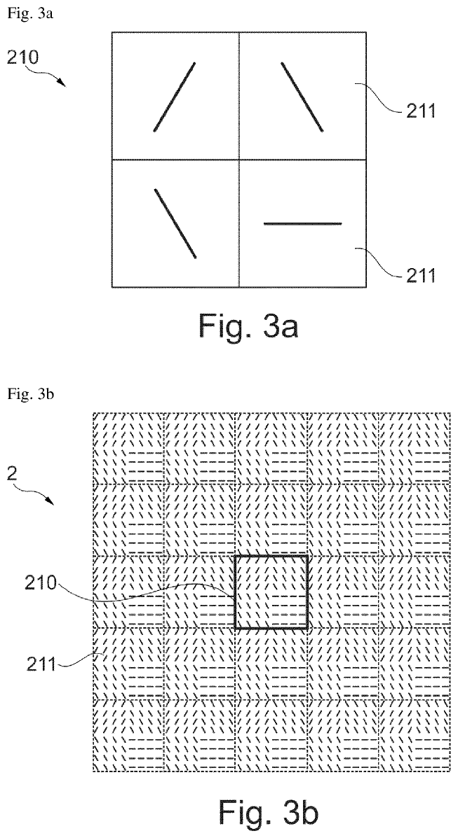

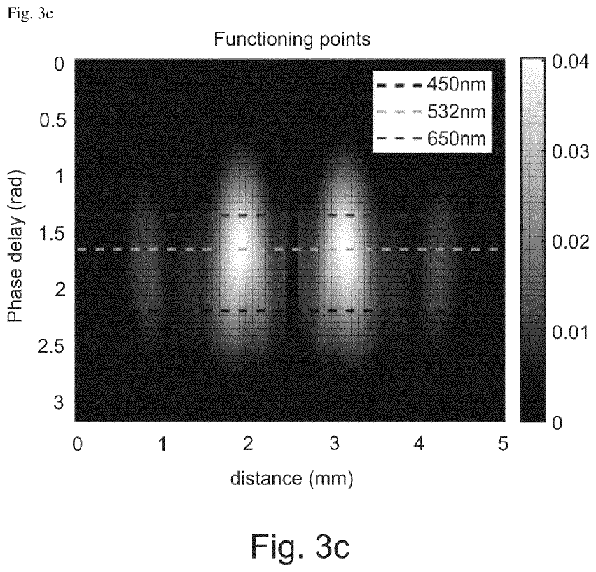

The characteristic size of a domain 211 may correspond to at least three times the size of one camera pixel, which allows to correctly resolve the diffraction pattern on the camera 3. For example, typical sCMOS camera have a pixel pitch of 6.5 um, leading to a domain 211 of at least 19.5 um and therefore the unit cell 210 of FIG. 3a of at least 39 um.

For phase imaging, the resolution is dominated by the typical size of the diffraction pattern on the camera. For example, with standard camera of 2048×2048 pixels, a phase image and/or a polarization image of 682×682 pixels can be generated.

Alternatively, as shown in FIGS. 3a and 3b, the mask 2 may be made of a periodic lattice of liquid crystals or metamaterials exhibiting linear birefringence, whose unit cell 210 is made of 2×2 domains 211, where relative fast axes orientation angles may have orientations rotating by {+π/3+7π/3 −π/3-π/3} radians, or equivalently absolute fast axes orientations of {+π/3; 27π/3; 0; 2π/3} with angles being defined modulo π, when running around the four adjacent domains clockwise and for which the retardance may be π/2+π/4 rad. For instance, for relative fast axes orientation angles of π/3 rad, the linear retardance may be 1.16×π/2 rad. In FIG. 3b, only 5×5-unit-cell lattice is represented but the number of unit cells of the periodic lattice may be larger. The masks in FIGS. 3a and 3b were optimized numerically for phase and polarization imaging by running a genetic algorithm to maximize the determinant of the 12×12 auto-correlation matrix C_{L}=( [symbol] Rᵢ|Rⱼ [symbol] _{L,G} [symbol] .

Alternatively, as shown in FIG. 1a, the unit cell of the polarization-modulating mask may be such that relative fast axes orientation angles have orientations rotating by {-π/4; 0; π/4; π/2} radians when running around the four adjacent domains clockwise and for which the retardance may be π/2±π/4 rad. This mask was optimized for polarization imaging only by running a genetic algorithm maximizing the determinant of the 4×4 auto-correlation matrix C_{L}=( [symbol] Rᵢ|Rⱼ [symbol] _{L,G} [symbol] .

Alternatively, as shown FIGS. 1a and 1c, the unit cell of the polarization modulating-mask may be a continuous version of the mask illustrated in FIG. 1a. The mask of FIG. 1a generates diffraction orders that can be filtered using a Fourier filter set 12, or directly optimizing the birefringent fast axis orientation pattern. This orientation can be defined as

$$θ = \frac{1}{2} ∠ \{ {e}^{\frac{i π}{4}} ( {e}^{ix} + {ie}^{iy} ) \}$$

in the case of FIG. 1c or by

$$θ = \frac{1}{2} ∠ \{ {e}^{\frac{i π}{4}} ( {e}^{ix} + {ie}^{iy} - {e}^{- ix} - {ie}^{- iy} ) \}$$

the case of FIG. 1b. The alternative patterns of FIG. 1c and 1b were obtained by considering two and four diffracted orders from the mask of FIG. 1a, respectively.

Alternatively, a liquid crystal lattice with random orientations of the domains of the unit cell may also be used for the mask 2. The main advantage of random orientation structures is the continuous tunability of the mask-camera distance while keeping the broadband capability over the entire visible spectrum.

For specific applications like the measure of optical rotation properties or circular dichroism, the mask 2 may be optimized to increase the desired sensitivity at the cost of a reduced sensitivity for other polarization properties.

### Algorithm

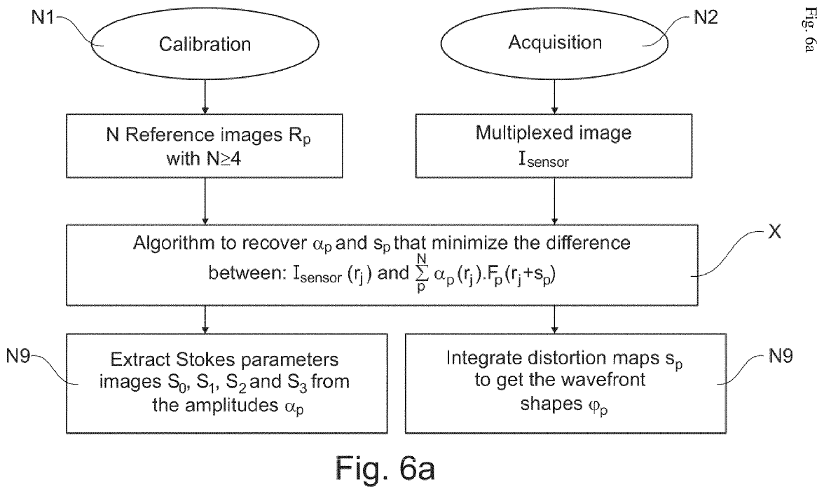

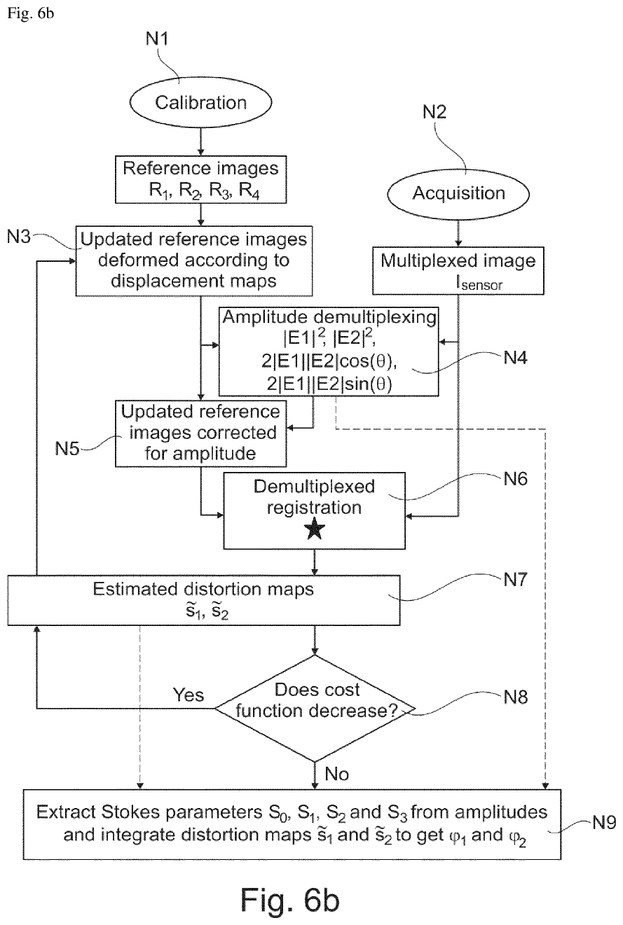

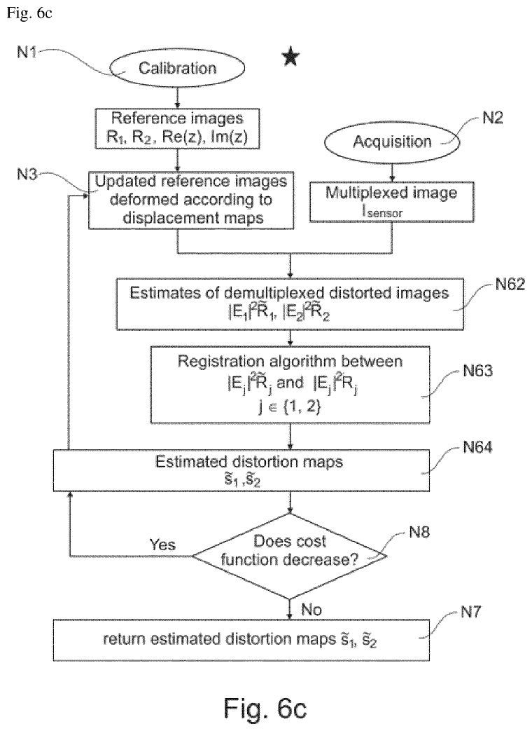

FIGS. 5 and 6a illustrate a method for generating data related to the polarization state and the polarization rate and to the wavefront shapes, of the incident light beam 51 of any polarization state and any polarization rate, from a single intensity image acquisition Iₛₑₙₛₒᵣ of the light beam, using the polarization and wavefront shape imaging system of FIG. 5A.

In a first step, the device is calibrated by recording at least four reference intensity patterns Rₚ, for example four reference intensity patterns R1, R2, R3 and R4, obtained for four specific polarization states, as shown in FIG. 5B.

Then, in a second step, the single intensity image Iₛₑₙₛₒᵣ is recorded with the same system 1 for the beam of interest 51, as shown in FIG. 5C, whose structure is expected to be a combination of reference intensity patterns.

The system 1 only needs to be calibrated once, and the calibration and acquisition steps can be achieved in the reverse order.

The deformation of those reference intensity patterns according to the references provides the wavefront gradient field, like in a Shack Hartmann sensor.

In a third step, the signal intensity image Iₛₑₙₛₒᵣ and the reference intensity images R1, R2, R3 and R4, are processed into a numerical algorithm X Iₛₑₙₛₒᵣ(rⱼ) and

$${\sum }_{p = 1}^{N} {α}_{p} ( {r}_{j} ) {R}_{p} ( {r}_{j} + {s}_{p , j} )$$

to recover the polarization weight (αₚ)_{p∈[1:N]} and the deformation data (sₚ).

Finally in a fourth step, the Stokes parameters S₀, S₁, S₂ and S₃ of the beam 51 are recovered from the polarization weight data (αₚ)_{p∈[1:N]} with an algorithm involving a matrix inversion and the wavefront shapes can be computed by two-dimensional integration of the distortion data (sₚ), as shown in FIG. 5D.

The algorithm X aims at measuring both the weights in each four reference channels together with the distortion maps associated with each four reference patterns.

The algorithm X described below aims at retrieving these two characteristics in a two-step “a” and “b” multi-iterative manner.

a. Retrieving of Amplitudes and Stokes Parameters, after Compensating Pattern Distortion, or Neglecting them.

The mask 2 may be modelled by a polarized-resolved transmission matrix T expressed in an orthonormal basis of polarization states as:

$$T = [ \begin{matrix}{T}_{11} & {T}_{12} \\ {T}_{21} & {T}_{22}\end{matrix} ]$$

where Tij are transmission coefficients that are functions of the position x,y on the mask.

One characteristic of these coefficients Tij is related to their spatial auto-correlation function:

$${C}_{i , j} ( x , y ) = \int \int {T}_{ij} ( u , v ) {T}_{ij}^{*} ( u - x , v - y ) dudv$$

More precisely, this function exhibits a peak with a maximum at position (x,y) (0,0), and the important property to be considered for wavefront sensing is the dimensions of this peak. These dimensions may be quantified by measuring the full width at half maximum of the peak.

For the mask 2, there are four Cᵢⱼ(x,y) functions having two typical dimensions each. Here, it is considered the smallest full width at half maximum w over autocorrelations of all Tij coefficients. w is called the smallest dimension of the correlation function of transmission matrix T.

The mask 2 diffracts light with a maximum angle scaling as k/w, which determines the spatial resolution (i.e. the phase pixel size) of the wavefront sensor then scaling as Xd/w where d is the working distance defined as the separation distance between the mask 2, or its image, and the plane of observation of the camera 3. The smaller w, the larger the phase pixel size and the worse the spatial phase resolution. Since the intensity structures at the camera plane, of same typical size w as the structures of the mask 2, must be resolved by camera pixels, the number of camera pixels required to get one phase pixel scales is (λd/w²)². To get the highest possible resolution, a wavefront sensor should thus minimize this quantity.

When an incident electric field Eᵢₙ propagates through the mask 2, the output field Eₒᵤₜ is determined by the polarization resolved transmission matrix T of the mask 2 according to:

$$[ \begin{matrix}{T}_{11} & {T}_{12} \\ {T}_{21} & {T}_{22}\end{matrix} ] [ \begin{matrix}{E}_{, 1} \\ {E}_{, 2}\end{matrix} ] = [ \begin{matrix}{E}_{out \text{.1}} \\ {E}_{out \text{.2}}\end{matrix} ] \qquad ( 1 )$$

where E_{in,1} and E_{in,2} designate the electric field Eᵢₙ projection over the basis of polarization states elements.

The intensity pattern Iₛₑₙₛₒᵣ measured at a distance d from the birefringent phase mask, or its image, can be expressed with a free space propagation function P_{d}:

$${I}_{sensor} = {\vert {P}_{d} ( {E}_{, 1} {T}_{11} + {E}_{, 2} {T}_{12} ) \vert}^{2} + {\vert {P}_{d} ( {E}_{, 1} {T}_{21} + {E}_{, 2} {T}_{22} ) \vert}^{2} \qquad ( 2 )$$

This expression can be simplified by introducing the four reference patterns. Experimentally, these reference patterns may be measured using vector beams with flat wavefronts, of known polarization states and normalized intensity.

Reference patterns are, for example, obtained using vectors elements

$${V}_{1} = [ \begin{matrix}1 \\ 0\end{matrix} ] , {V}_{2} = [ \begin{matrix}0 \\ 1\end{matrix} ] , {V}_{3} = \frac{1}{\sqrt{2}} [ \begin{matrix}1 \\ 1\end{matrix} ] and {V}_{4} = \frac{1}{\sqrt{2}} [ \begin{matrix}1 \\ i\end{matrix} ] .$$

In the Cartesian coordinates basis (x,y) for instance, these vectors represent linearly polarization with angles 0°, 90°, 45°, and right-handed circular polarization, respectively.

Based on this chosen set of vector beams, the corresponding reference patterns are:

$${R}_{1} = {\vert {P}_{d} ( {TV}_{1} ) \vert}^{2} = {\vert {T}_{11} \vert}^{2} + {\vert {T}_{21} \vert}^{2} \qquad ( 3.1 )$$

$${R}_{2} = {\vert {P}_{d} ( {TV}_{2} ) \vert}^{2} = {\vert {T}_{12} \vert}^{2} + {\vert {T}_{22} \vert}^{2} \qquad ( 3.2 )$$

$${R}_{3} = {\vert {P}_{d} ( {TV}_{3} ) \vert}^{2} = \frac{1}{2} {\vert {T}_{11} + {T}_{12} \vert}^{2} + \frac{1}{2} {\vert {T}_{21} + {T}_{22} \vert}^{2} \qquad ( 3.3 )$$

$${R}_{4} = {\vert {P}_{d} ( {TV}_{4} ) \vert}^{2} = \frac{1}{2} {\vert {T}_{11} + {iT}_{12} \vert}^{2} + \frac{1}{2} {\vert {T}_{21} + {iT}_{22} \vert}^{2} \qquad ( 3.4 )$$

In practice, for the sake of readability of equations, it is more convenient to replace R3 and R4 and to define the complex-numbered pattern z:

$$z = {T}_{11}^{*} \cdot {T}_{12} + {T}_{21}^{*} \cdot {T}_{22} \qquad ( 3.5 )$$

whose real and imaginary parts can be obtained from R3 and R4 thanks to:

$$R ( z ) = {R}_{3} - \frac{1}{2} ( {R}_{1} + {R}_{2} ) \qquad ( 3.5 a )$$

$$I ( z ) = {R}_{4} - \frac{1}{2} ( {R}_{1} + {R}_{2} ) \qquad ( 3.5 b )$$

R1 and R2 are the intensity patterns measured with the eigenvectors of the chosen polarization basis and z quantifies how the two polarization states elements will interfere after being mixed by the birefringent device.

Finally, for an incident vector field Eᵢₙ with negligible phase gradient, the intensity pattern can be expressed as:

$${I}_{s ensor} = {\vert {E}_{, 1} \vert}^{2} {R}_{1} + {\vert {E}_{, 2} \vert}^{2} {R}_{2} + 2 \vert {E}_{, 1} \vert \cdot \vert {E}_{, 2} \vert \cdot R ( z \cdot {e}^{i θ} ) \qquad ( 4 a )$$

$${I}_{sensor} = {\vert {E}_{, 1} \vert}^{2} {R}_{1} + {\vert {E}_{, 2} \vert}^{2} {R}_{2} + 2 \vert {E}_{, 1} \vert \cdot \vert {E}_{, 2} \vert \cdot [ R ( {z}_{f} ) \cdot cos ( θ ) + I ( {z}_{f} ) \cdot sin ( θ ) ] \qquad ( 4 b )$$

with |E_{,1}| and |E_{,2}| the amplitudes of the incident field for each polarization stats element, and θ=arg(E_{,2}Eᵢ₁*) the phase delay between these two polarizations.

In Eq. 4b, the weights, |E_{,1}|², |E_{,2}|², 2|Eᵢ₁∥E_{,2}|cos(θ) and 2|E_{,1}∥E_{,2}|sin(θ) of the contribution to R1, R2, R(z), and I(z), respectively, may be obtained by using a cross-correlation product if the four reference patterns are perfectly orthonormal. Preferentially, a least square minimization algorithm may be used.

Once the weights of the contributions to R1, R2, R(z), and I(z), in Eq. 4b, are obtained, the Stokes parameters S₀, S₁, S₂ and S₃ may be computed.

For instance, if the basis is the canonical basis, i.e. E_{,1} is the field projection along x and E_{,2} the field projection along y, then the relation between E_{,1}, Eᵢ₂, θ on the one hand, and S0, S1, S2 and S3 on the other hand is:

$${S}_{0} = {\vert {E}_{, 1} \vert}^{2} + {\vert {E}_{, 2} \vert}^{2} \qquad ( 5 a )$$

$${S}_{1} = {\vert {E}_{, 1} \vert}^{2} - {\vert {E}_{, 2} \vert}^{2} \qquad ( 5 b )$$

$${S}_{2} = 2 \vert {E}_{, 1} \vert \cdot \vert {E}_{, 2} \vert cos ( θ ) \qquad ( 5 c )$$

$${S}_{3} = 2 \vert {E}_{, 1} \vert \cdot \vert {E}_{, 2} \vert sin ( θ ) \qquad ( 5 d )$$

Alternatively, another example is the case of a basis consisting in two circular polarization vectors. In this case, Stokes parameters are obtained according to:

$${S}_{0} = {\vert {E}_{, 1} \vert}^{2} + {\vert {E}_{, 2} \vert}^{2} \qquad ( 6 a )$$

$${S}_{1} = 2 \vert {E}_{, 1} \vert \cdot \vert {E}_{, 2} \vert cos ( θ ) \qquad ( 6 b )$$

$${S}_{2} = - 2 \vert {E}_{, 1} \vert \cdot \vert {E}_{, 2} \vert sin ( θ ) \qquad ( 6 c )$$

$${S}_{3} = \vert {E}_{, 1} \vert - {\vert {E}_{, 2} \vert}^{2} \qquad ( 6 d )$$

For a partially polarized beam, the intensity at the detector may be written:

$${I}_{sensor} = \frac{{S}_{0}}{2} \cdot {I}_{unpo} + \frac{{S}_{1}}{2} \cdot ( {I}_{0} - {I}_{90} ) + \frac{{S}_{2}}{2} \cdot ( {I}_{45} - {I}_{- 45} ) + \frac{{S}_{3}}{2} \cdot ( {I}_{r} - {I}_{l} )$$

with Iᵤₙₚₒ the pattern obtained on the camera with an unpolarized beam (S0=1; S1=S2=S3=0), I₀, I₉₀, I₄₅ and I₋₄₅ respectively the patterns obtained with a linear polarization oriented at 0, 90, 45 and −45 degrees, Iᵣ and Iₗ the pattern obtained with the two circular polarizations.
   b. Retrieving of Distortion Maps, Assuming Stokes Parameters are Known from “a”

For distorted wavefronts, the patterns may also be distorted. In the Fresnel approximation and within the angular memory effect of the birefringent device, the measured intensity pattern Iₛₑₙₛₒᵣ may be assumed to be locally translated by an amount proportional to the local wavefront gradient. The intensity at the detector is then:

$${I}_{sensor} = {\vert {E}_{, 1} \vert}^{2} \cdot {R}_{1} ( \vec{r} - \vec{{s}_{1}} ) + {\vert {E}_{, 2} \vert}^{2} \cdot {R}_{2} ( \vec{r} - \vec{{s}_{2}} ) + 2 \vert {E}_{, 1} \vert \cdot \vert {E}_{2} \vert \cdot R ( {z}_{f} . {e}^{i θ} ) \qquad ( 7 a )$$

$${I}_{sensor} = {\vert {E}_{, 1} \vert}^{2} \cdot {R}_{1} ( \vec{r} - \vec{{s}_{1}} ) + {\vert {E}_{, 2} \vert}^{2} \cdot {R}_{2} ( \vec{r} - \vec{{s}_{2}} ) + 2 \vert {E}_{, 1} \vert \cdot \vert {E}_{, 2} \vert \cdot [ R ( {z}_{f} ) \cdot cos ( θ ) + I ( {z}_{f} ) \cdot sin ( θ ) ] \qquad ( 7 b )$$

where

$$\vec{{s}_{1}} = \frac{d}{k} \vec{∇ {φ}_{1}} and \vec{{s}_{2}} = \frac{d}{k} \vec{∇ {φ}_{2}}$$

are the distortion maps of the patterns, proportional to the gradient of the spatial phase \vec{∇φ₁} and \vec{∇φ₂} of E_{,1} and E_{,2} respectively, k being the wavenumber of the beam and d the distance between the mask 2, or its image, and the camera sensor 3.

The gradient of the phase for each polarization and z_{f} can then be approximated at first order Taylor expansion by:

$${z}_{f} = z + \frac{d}{k} \vec{∇ {φ}_{1}} \cdot ( \vec{∇ {T}_{11}} \cdot {T}_{12}^{*} + \vec{∇ {T}_{21}} \cdot {T}_{22}^{*} ) + \frac{d}{k} \vec{∇ {φ}_{2}} \cdot ( \vec{∇ {T}_{12}} \cdot {T}_{11}^{*} + \vec{∇ {T}_{22}} \cdot {T}_{21}^{*} ) \qquad ( 8 )$$

The unknown coherent vector field can be measured from the diffraction pattern Iₛₑₙₛₒᵣ measured in the camera 3 at a distance from the phase mask 2, or its image, if the relevant parameters |E_{,1}|, |E_{,2}, \vec{∇φ₁}, \vec{∇φ₂} and θ=φ₂−φ₁ can be extracted from equation (7a).

Algorithm X is run by iteratively applying steps a and b above, which means:
a. recovering |E_{,1}|, |E_{,2}| and θ with a least square minimization,
b. recovering \vec{∇φ₁} and \vec{∇φ₂}, or equivalently distortion maps [symbol] and [symbol] , with registration algorithms. Other algorithms than those presented here may also be used in the family of convolutional or model-based neuronal networks. Algorithms based on non-rigid pattern recognition rather than least square minimization may also be used.

The detailed workflows of algorithm X are presented in FIGS. 6b and 6c.

At the first iteration, the wavefront gradient, and thus distortion maps [symbol] and [symbol] , are assumed to be zero, and the set of equations 5a, 5b, 5c and 5d may be solved at each pixel assuming close neighbouring pixels have the same solution thanks to a pseudoinverse matrix operation.

A first estimate of |E_{,1}|, |E_{,2}| and θ may then be obtained in step N4, after the acquisition of reference images in step N1 and the acquisition of Iₛₑₙₛₒᵣ in step N2. With these estimates, weighted reference images |Eᵢⱼ|². Rⱼ may be generated in step N5 by multiplying reference images by the intensity estimated in each polarization state associated with each corresponding reference beam. These updated reference images are necessary to properly estimate the distortion maps.

[symbol]

Next, at each iteration an estimate of R₁(\vec{r}−\vec{s₁}) and R₂(\vec{r}−\vec{s₂}),called [symbol] and [symbol] may be generated in step N6, more precisely in sub step N62, by subtracting the other contributions according to equations:

$${\vert {E}_{, 1} \vert}^{2} \cdot \text{?} = {I}_{sensor} - {\vert {E}_{, 2} \vert}^{2} \cdot {R}_{2} ( \vec{r} - \text{?} ) - 2 \vert {E}_{, 1} \vert \cdot \vert {E}_{, 2} \vert \cdot [ R ( {z}_{f} ) \cdot cos ( θ ) + I ( {z}_{f} ) \cdot sin ( θ ) ] \qquad ( 9 a )$$

$${\vert {E}_{, 2} \vert}^{2} \cdot \text{?} = {I}_{sensor} - {\vert {E}_{, 1} \vert}^{2} \cdot {R}_{1} ( \vec{r} - \text{?} ) - 2 \vert {E}_{, 1} \vert \cdot \vert {E}_{, 2} \vert \cdot [ R ( {z}_{f} ) \cdot cos ( θ ) + I ( {z}_{f} ) \cdot sin ( θ ) ] \qquad ( 9 b )$$

where [symbol] and [symbol] are distortion maps estimated at the former iteration.

A new estimate of [symbol] and [symbol] can then be obtained in step N64 assuming that [symbol] =Rⱼ(\vec{r}−\vec{sⱼ}) based on a non-rigid registration algorithm applied to |Eᵢⱼ|². [symbol] and |Eᵢⱼ|². Rⱼ in step N63. Noteworthy, the two other reference patterns R(z) and I(z) may also be registered according to estimated distortion maps [symbol] and [symbol] but in practice, this operation may be unnecessary for small enough distortions.

Finally, this process is iterating by updating the amplitudes and phases at each iteration in steps N3 and N5.

At each iteration, a cost function is computed to check whether Eq. 7 is satisfied in step N8.

The Stokes parameters may finally be reconstructed in step N9 from recovering |Eᵢ₁|, |E_{,2}| and θ using the appropriate equations depending on the polarization basis chosen.

Furthermore, spatial phase gradients

$$\vec{∇ {φ}_{1}} = \frac{k}{d} \text{?} and \vec{∇ {φ}_{2}} = \frac{k}{d} \text{?}$$

are numerically integrated to get the spatial phases φ₁ and φ₂ of E_{in,1} and E_{in,2}.

As a second possible reconstruction algorithm, both |E_{,1}|, |E_{,2}|, θ and \vec{∇φ₁} and \vec{∇φ₂} (or equivalently [symbol] and [symbol] ) may be directly recovered by a least-square minimization based on a first order Taylor expansion of Eq. 7b (for small displacements) involving the gradients of the reference intensity patterns. The fact that the auto-correlation matrix between both reference intensity patterns, and their respective gradient maps be invertible, ensure the unicity of the reconstruction.

In a nutshell either in the case of a fully polarized or a partially polarized beam, the pattern Iₛₑₙₛₒᵣ at the camera plane can be expressed as a linear combination of reference intensity patterns deformed by displacement vector maps sₚ:

$${I}_{sensor} ( {r}_{j} ) = {\sum }_{p = 1}^{4} {α}_{p} ( {r}_{j} ) {F}_{p} ( {r}_{j} + {s}_{p , j} )$$

with Fₚ meaning F₁ to F₄ functions defined below:

$${F}_{1} = {R}_{1} , {F}_{2} = {R}_{2} , {F}_{3} = R ( z ) , {F}_{4} = I ( z )$$

which can be simplified with a first order Taylor expansion for small enough displacements amplitudes of s_{p,j}:

$${I}_{sensor} ( {r}_{j} ) = {\sum }_{p = 1}^{4} {α}_{p} ( {r}_{j} ) [ {F}_{p} ( {r}_{j} ) + {s}_{p , j} \cdot ∇ {F}_{p} ( {r}_{j} ) ]$$

which can be written:

$${I}_{sensor} ( {r}_{j} ) = {\sum }_{p = 1}^{12} {α}_{p} ( {r}_{j} ) {F}_{p} ( {r}_{j} ) \\ with : \begin{matrix}{F}_{5} = {\partial }_{x} {R}_{1} & {F}_{6} = {\partial }_{x} {R}_{2} & {F}_{7} = {\partial }_{x} R ( z ) & {F}_{8} = {\partial }_{x} I ( z ) \\ {F}_{9} = {\partial }_{y} {R}_{1} & {F}_{10} = {\partial }_{y} {R}_{2} & {F}_{11} = {\partial }_{y} R ( z ) & {F}_{12} = {\partial }_{y} I ( z )\end{matrix}$$

A reconstruction algorithm, shown in FIG. 6a, thus consists in minimizing the following Lagrangian:

$$L = {\sum }_{j} {\vert {I}_{sensor} ( {r}_{j} ) - {\sum }_{p = 1}^{4} {α}_{p} ( {r}_{j} ) {F}_{p} ( {r}_{j} + {s}_{p , j} ) \vert}^{2}$$

which can be approximated by minimizing:

$$L = {\sum }_{j} {\vert {I}_{sensor} ( {r}_{j} ) - {\sum }_{p = 1}^{12} {α}_{p} ( {r}_{j} ) {F}_{p} ( {r}_{j} ) \vert}^{2}$$

where, the summation over j is performed over a set of camera pixels, corresponding for example to the size of four domains.

The reconstruction metric presented above is a squared 2-norm. Alternatively, it may be also the 2-norm only, or the 1-norm or some other norms. Alternatively, a deep learning algorithm like a convolutional neuronal network may also be trained to recover Stokes parameters and wavefronts from experimental data. Although parameters of the neuronal network are typically optimized by minimizing a 2-norm over a big set of data, the minimization achieved on a single set of experimental data might have any proper norm definition.

According to previous notations, αₚ are defined in the following way:

$$\begin{matrix}{α}_{1} = {\vert {E}_{, 1} \vert}^{2} & {α}_{2} = {\vert {E}_{, 2} \vert}^{2} & {α}_{3} = 2 \vert {E}_{, 1} \vert {\vert {E}_{, 2} \vert}^{2} cos θ \\ {α}_{4} = 2 \vert {E}_{, 1} \vert {\vert {E}_{, 2} \vert}^{2} sin θ & {α}_{5} = - {\vert {E}_{, 1} \vert}^{2} {\partial }_{x} {R}_{1} \cdot {s}_{1 , x} & {a}_{6} = - {\vert {E}_{, 2} \vert}^{2} {\partial }_{x} {R}_{2} \cdot {s}_{1 , x} \\ {α}_{9} = - {\vert {E}_{, 1} \vert}^{2} {\partial }_{y} {R}_{1} \cdot {s}_{1 , y} & {α}_{10} = - {\vert {E}_{2} \vert}^{2} {\partial }_{y} {R}_{2} \cdot {s}_{1 , y} & \end{matrix}$$

αⱼ for j ∈{7, 8, 11, 12} having complicated expressions that are not essential for the reconstruction.

### Results

In FIGS. 2b, 3c and 4, the ratio of the minimum eigenvalue over the maximum one of the 12×12 auto-correlation matrix C_{L}=( [symbol] Fᵢ|Fⱼ [symbol] _{L,G} [symbol] constructed from both the reference intensity patterns and their respective intensity gradient maps, is computed as a function of the distance d and the uniform phase delay induced by the liquid crystal, to assess the capability of the system 1 of performing polarization reconstruction, respectively if the system comprises the mask 2 of FIG. 2a, the mask 2 of the FIGS. 3b and in a system comprising a polarization modulating mask with random orientations of the domains 211.

In FIG. 2b, four regions appears where this ratio is not negligible for various distances d, around 700 mm, 1500 m, 3500 mm and 4500 mm, which implies that it is possible to tune the sensitivity of the wavefront sensing capability with the same mask 2.

In FIG. 3c, four regions appears where this ratio is not negligible for various distances d, around 850 mm, 2000 m, 3300 mm and 4400 mm, which implies that it is possible to tune the sensitivity of the wavefront sensing capability with the same mask 2.

With a retardance thickness of 158 nm for the liquid crystal layer, which corresponds to a quarter-wavelength retardation for wavelength of 632 nm, the system 1 with the mask of FIG. 2a, or the mask of FIG. 3c, can simultaneously work over the entire visible range as illustrated by the three doted lines, corresponding to wavelengths 450 nm, 532 nm and 650 nm, on the functioning point graph.

The patterns of the unit cells 210 showed in FIGS. 2a and 3c, are therefore suitable for uniform phase retardance.

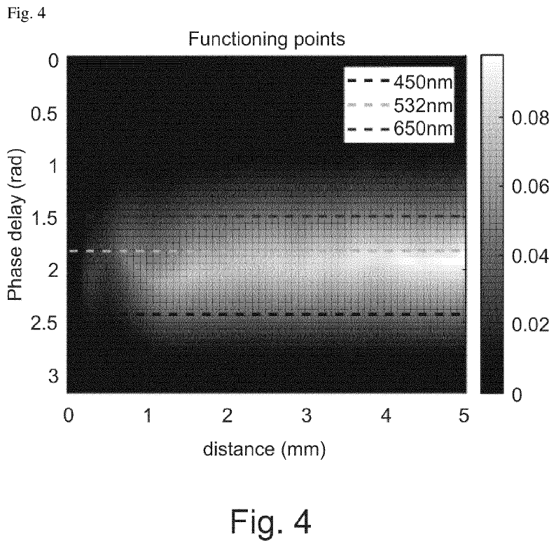

In FIG. 4, a random polarization modulating mask 2 with a liquid crystal thickness of 150 nm was used. The figure shows that the price to pay for random orientations of the domains 211 is a small loss in resolution to ensure the local orthogonality of the four reference patterns.

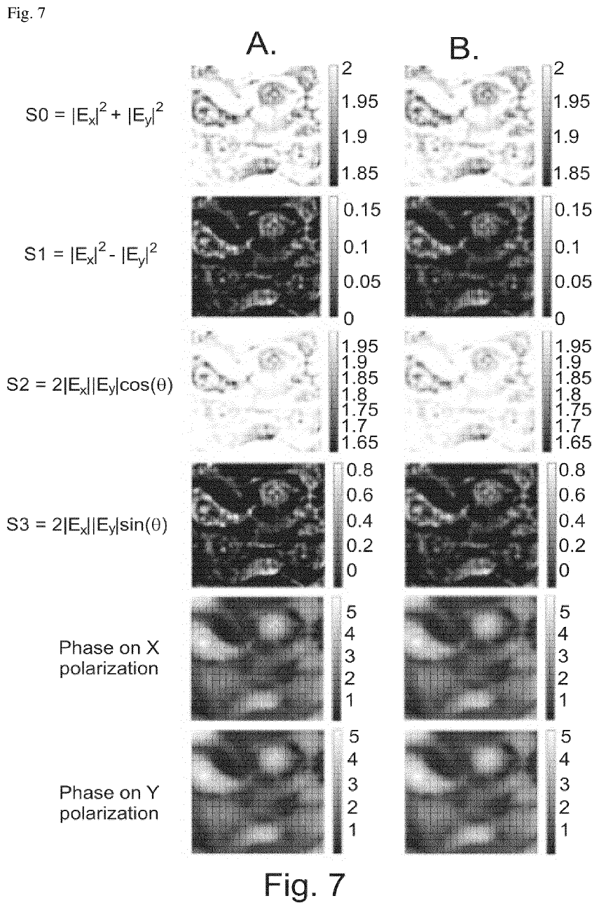

FIG. 7 shows simulations results with the mask of FIG. 2a. Birefringent cells are generated numerically based on experimental real high resolution phase images. The images in column B are images reconstructed with the algorithm described above. The numerically generated images are shown in column A for comparison.

The reconstructed images of column B appears to be almost identical to the true images of column A, showing that the reconstruction algorithm described above allows retrieving the Stokes parameters and the phases of an incident light beam for samples such that biological cells.

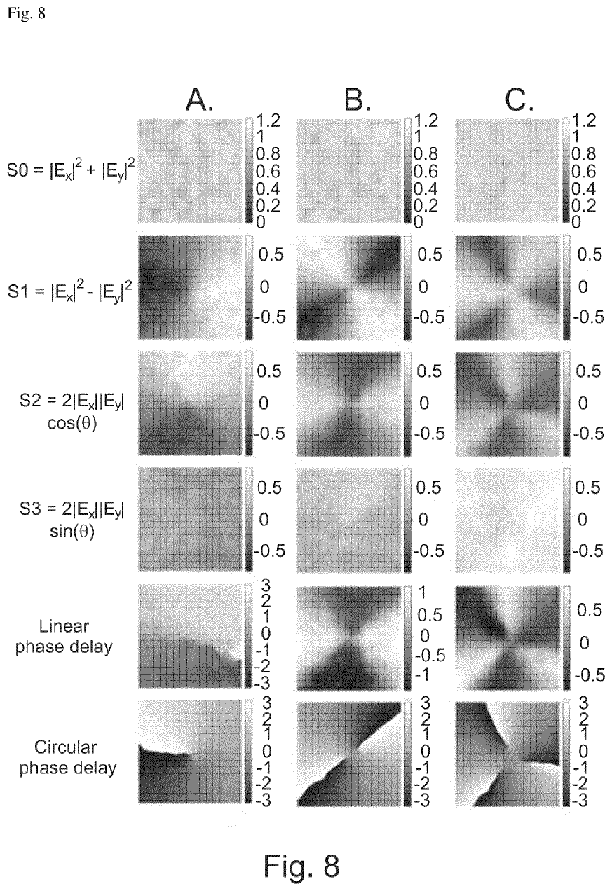

FIG. 8 shows experimental results obtained with the system 1 of FIG. 1. It shows polarization images of liquid crystal Q-plates. The polarization modulating mask 2 used in the experiment is a thin layer of white paint. Three Q-plates with topological charges equal to ½, 1 and 3/2 are imaged in polarization and phase with the system 1, respectively in columns A, B and C.

One can observe that the images of first line, S0, and the fourth line, S3, are quite homogeneous. S0 represents the measured intensity of the whole light beam and S3 represents the intensity of the circularly polarized light from the whole light beam. These two intensities are supposed to be almost homogeneous. The reconstruction allows then to compute right Stokes parameter S0 and S3.

### Comparative Example

Table 1 below shows a comparison between the polarization modulating mask 2 of FIGS. 2a to 2e and the meta surface mask acting as an array of polarized-dependent micro-lens of article Yang, Z., Wang, Z., Wang, Y. et al. Generalized Hartmann-Shack array of dielectric metalens sub-arrays for polarimetric beam profiling. Nat Commun 9, 4607 (2018).

TABLE 1

| | | Meta surface |
|---|---|---|
| | | mask acting as |
| | Polarization | an array of |
| | modulating | polarized- |
| | mask 2 (FIG. | dependent |
| | 2a to 2e) | micro-lens |
| Smallest dimension w (um) of auto- | 39 | λ/(2NA) = 2.34 |
| correlation functions of the coefficients | | |
| of the polarization-resolved | | |
| transmission or reflection matrix T | | |
| Wavelength λ (um) | 0.532 | 1.5 |
| Distance d (um) | 5000 | 30 |
| Rayleigh range z_{R} = πw²/λ (um) | 9000 | 11.5 |
| minimal number of required camera | 3 | 67.1 |
| pixel per phase and polarization | | |
| pixel (λd/w²)² | | |

The mask 2 is working in the visible spectral range where the camera 3 is the most efficient and has the largest number of pixels, while the meta surface mask is working in the infrared domain.

The meta surface mask splits the impinging beam into beamlets, each beamlet passing through a meta micro-lens. The number of camera pixels, 67.1, per sampling point is then very high because the distance between each sampling point equals the size of micro-lenses. In comparison, the mask 2 does not split the beam into beamlets in the plane of study, it spreads the light energy over the full camera surface, so optimizing the spatial density of sampling point and thus the spatial resolution of the phase and polarimetric images: the number of camera pixel per sampling point is 3.

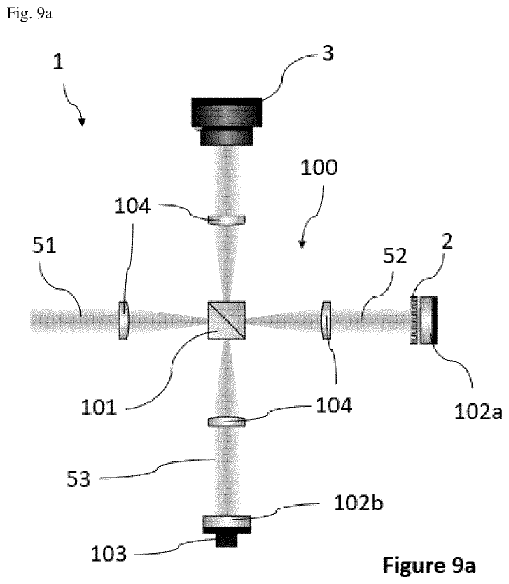

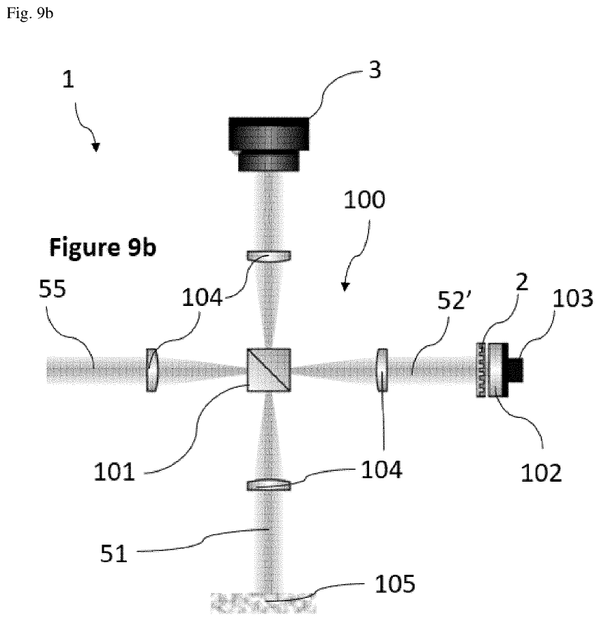

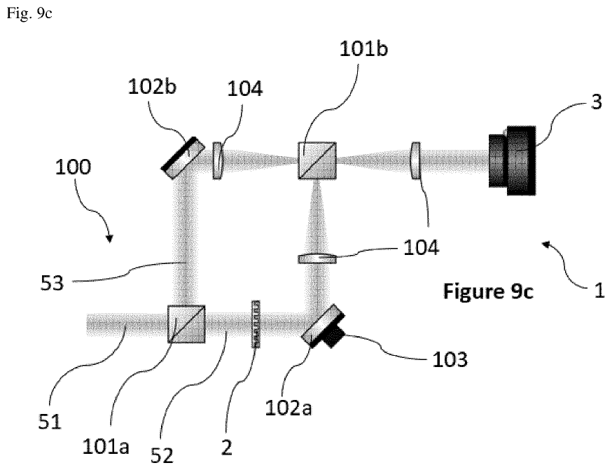

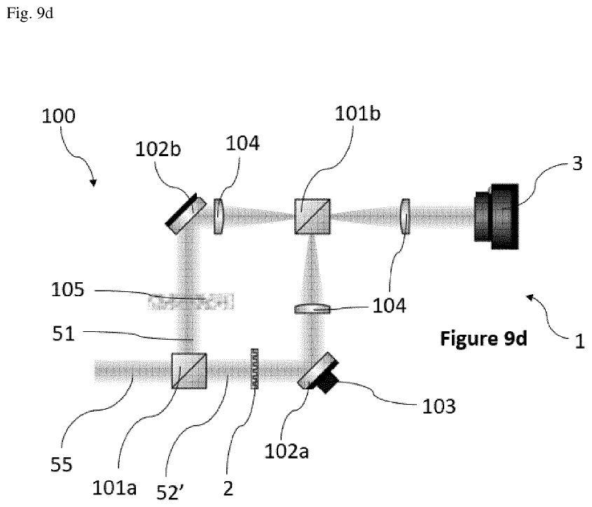

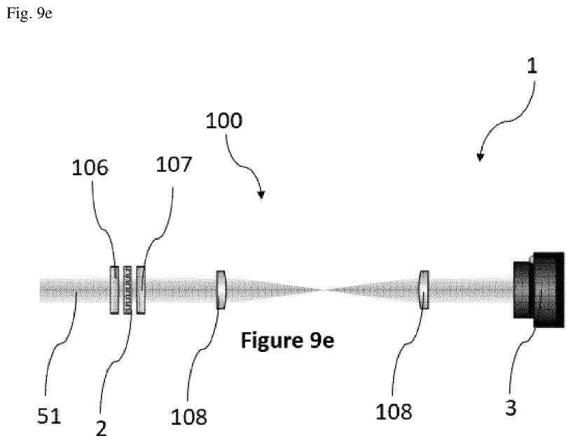

Interferometer In FIGS. 9a and 9b, the polarization and wavefront shape imaging system 1 comprises a Linnik interferometer 100, an intensity camera sensor 3 and a polarization modulating mask 2 inside the interferometer 100.

The Linnik interferometer 100 of FIG. 9a comprises a beam-splitter 101, two mirrors 102a and 102b, one piezo-electric translation stage 103 and a set of lenses 104.

The beam-splitter 101 splits the incident light beam 51 into two parts 52 and 53. One part 52 of the beam is sent onto the polarization modulating mask 2 and reflected onto a first mirror 102a; the second part 53 is reflected onto a second mirror 102b. The two parts 52 and 53 of the beam are then recombined with the same beam-splitter 101 and sent onto the intensity sensor camera 3. The polarization modulating mask 2 is imaged at a distance d, for example at a distance equal to zero, from the intensity sensor camera 3 using the set of lenses 104. Preferentially, the first mirror 102a is close to the polarization modulating mask 2.

The Linnik interferometer 100 of FIG. 9b comprises a beam-splitter 101, a mirror 102, a piezo-electric translation stage 103, a set of lenses 104 and a reflecting and/or backscattering sample 105.

The beam-splitter 101 splits a beam 55 into two parts 51 and 52′. One part 51 of the beam illuminates the sample 105 to be characterized. The second part 52′ illuminates the mirror 102. The beam 51 that is reflected and/or backscattered by the sample 105 is the incident light beam 51 and is recombined with the other part 52′ of the beam using the same beam-splitter 101 and sent onto the intensity sensor camera 3. In this implementation, reference intensity patterns Iₛₑₙₛₒᵣ are recorded by changing the sample 105, for instance by moving it, or replacing it by a back reflecting mirror. This implementation is an improvement of an optical coherence tomographer (OCT), where the use of a light source with low temporal coherence typically allows obtaining images with axial optical sectioning. In this specific implementation, polarization and phase resolved OCT images will be obtained with optical sectioning ability. Optical sectioning is referring to the ability of an optical instrument to image only one transverse plane of a thick sample, in general the focal plane of an imaging lens, by suppressing information coming from out-of-focus regions of the sample.

In FIGS. 9c and 9d, the polarization and wavefront shape imaging system 1 comprises a Mach-Zehnder interferometer 100, an intensity camera sensor 3 and a polarization modulating mask 2 inside the interferometer 100.

The Mach-Zehnder interferometer of FIGS. 9c and 9d comprise two beam-splitters 101a and 101b, two mirrors 102a and 102b, one piezo-electric translation stage 103 and a set of lenses 104.

In FIG. 9c, a first beam-splitter 101a splits the incident light beam 51 into two parts 52 and 53. One part 52 of the beam goes through the polarization modulating mask 2. The two parts 52 and 53 of the incident light beam are then recombined using a second beam-splitter 101b before reaching the intensity sensor camera 3. The polarization modulating mask 2 is imaged at a working distance d, for example at a distance equal to zero, from the intensity sensor camera 3 using a set of lenses 104.

In FIG. 9d, a beam 55 is split into two parts 51 and 52′ using a beam splitter 101a.

One part 51 of the beam is transmitted through a sample 105 to be characterized. The other part 52′ illuminates a mirror 102a. The part 51 of the beam crossing the sample 105 is the incident light beam 51 and is recombined with the other part 52′ of the beam using a second beam-splitter 101b, and sent onto the intensity sensor camera 3. In this implementation, reference intensity patterns Iₛₑₙₛₒᵣ are recorded by changing the sample 105, for instance by moving it, or by removing it, or by replacing it with another optical element. In this configuration, the use of a light source with low temporal coherence allows obtaining polarized images with axial optical sectioning.

In FIG. 9e, the polarization and wavefront shape imaging system 1 comprises a Fabry-Perot interferometer 100, an intensity camera sensor 3 and a polarization modulating mask 2 inside the interferometer 100.

The Fabry-Perot interferometer 100 comprises two partially reflecting mirrors 106 and 107. The optical assembly composed of the polarization modulating mask 2 and the two mirrors 106 and 107 is imaged at a distance d from the intensity sensor camera 3 with a relay lens system 108. The advantage of this implementation is to be more compact that former implementations and to allow placing the optical assembly composed of the mask 2 and the two mirrors 106 and 107 in a plane conjugate to the intensity sensor camera 3 to potentially improve the spatial resolution of polarization and/or phase images.

1. A method for generating data related at least to the polarization state and the polarization rate, and advantageously to the wavefront shapes, of an incident light beam of any polarization state and any polarization rate,
from a single intensity image acquisition Iₛₑₙₛₒᵣ of said light beam,
using a polarization and wavefront shape imaging system which comprises a polarization modulating mask and an intensity sensor camera:
the polarization modulating mask being a diffractive optical element comprising a two-dimensional birefringent diffraction grating consisting in a two-dimensional periodic lattice having any structure of any of the five possible two-dimensional Bravais lattices: oblique lattice, square lattice, rectangular lattice, hexagonal lattice or rhombic lattice,
the two-dimensional periodic lattice being periodic along two transverse dimensions with at least one transverse period w and based on an unit cell (210), each unit cell exhibiting a two-dimensional birefringent motif-, advantageously with a unit cell being a square unit cell with the size of the side w, the polarization modulating mask being thinner than one tenth of the Rayleigh distance of the mask z_{R}, with z_{R}=πw²/λ_{average}, λ_{average} being the average wavelength of the incident light beam,
said polarization modulating mask having:
a polarization-resolved transmission or reflection matrix T,
the property to generate interference patterns between any two cross-polarized impinging beams, at several planes transverse to the propagation axis, the several transverse planes lying at several working distances (d) from the input plane of said polarization modulating mask,
the interference patterns so depending on the two respective amplitudes and the relative phase of said two cross-polarized impinging beams,
the property to generate at least one set of four reference intensity patterns, at least at one working distance (d) from the input plane of the polarization modulating mask, when illuminated by four respective impinging reference light beams, said reference intensity patterns exhibiting structures of size equal to said transverse period w or smaller at said working distance (d),
the working distance (d) being smaller than one tenth of wL/λ_{average}, with L the diagonal length of a captor of the intensity sensor camera and λ_{average} being the average wavelength of the incident light beam,
the four impinging reference light beams having polarization states defining all together a tetrahedron of non-zero volume when represented on the polarization Poincaré sphere,
each said set of four reference intensity patterns forming a Stokes parameters image basis, meaning that the auto-correlation matrix C_{L}=( [symbol] RᵢRⱼ [symbol] _{L,G} [symbol] of the corresponding four reference intensity patterns is invertible, Rᵢ being the reference intensity pattern of polarization state i,
the intensity sensor camera being placed downstream from said polarization modulating mask for recording the intensity image Iₛₑₙₛₒᵣ of the incident light beam, at least a part of which having been reflected by or transmitted through the polarization modulating mask, or alternatively at least a part of the incident light beam having interfered with another beam reflected by or transmitted through the polarization modulating mask,
said intensity image Iₛₑₙₛₒᵣ lying at any of the several of said working distances (d) from the input plane of the polarization modulating mask,
the method comprising:
(A) having previously recorded one set of at least four reference intensity patterns (N1) with the intensity sensor camera of the imaging system, the reference intensity patterns being formed at one given of said working distances (d) from the input plane of the polarization modulating mask,
each reference intensity pattern having been generated by a respective impinging reference light beam of known polarization rate and known polarization state, and advantageously of known wavefront shape,
the polarization states of the impinging reference light beams defining all together a polyhedron of non-zero volume when represented on the polarization Poincaré sphere and reference intensity patterns defining a Stokes parameters image basis at the working distance (d),
thus allowing the determination of the full polarization state of the impinging light beam,
(B) recording the single intensity image Iₛₑₙₛₒᵣ of said incident light beam with the intensity camera sensor, the single intensity image being formed at the same given working distance (d) from the input plane of the polarization modulating mask,
(C) processing the single intensity image Iₛₑₙₛₒᵣ based on the reference intensity patterns to generate the data related to the polarization state and the polarization rate, and advantageously to the wavefront shapes of the incident light beam.

2. Method according to claim 1, wherein the intensity sensor camera is placed so that the intensity image Iₛₑₙₛₒᵣ is lying at a working distance (d) shorter than Rayleigh distance of the mask z_{R}, with z_{R}=πw²/λ_{average}, λ_{average} being the average wavelength of the incident light beam.

3. Method according to claim 1, wherein an additional step is performed before step (A) in order to realize the unit cell design of the polarization modulating mask, the additional step comprising:
i. recording or computing numerically four reference intensity patterns R₁, R₂, R₃, and R₄ with the polarization and imaging system, each reference intensity pattern being generated by a respective impinging light beam, the four impinging reference light beams having normalised intensity and four known polarization states defining a non-zero volume in the Poincare sphere,
ii. Calculating the auto-correlation matrix C_{L}=( [symbol] Rᵢ|Rⱼ [symbol] _{L,G} [symbol] where Rₚ are the reference intensity patterns recorded for the reference intensity light beam, and
iii. if C_{L} is not invertible or if the ratio of eigen-values eₘᵢₙ/eₘₐₓ of C_{L} is smaller than 1.5% or 1%, wherein eₘᵢₙ and eₘₐₓ are respectively the smallest and the largest eigen-values of the auto-correlation matrix C, modifying the unit cell of the polarized-resolved matrix of the polarization modulating mask and repeating steps i. and ii. until the conditions of the step iii. are fulfilled.

4. Method according to claim 1, wherein an additional step is performed before step (A) in order to realize the unit cell design of the polarization modulating mask, the additional step comprising:
i. recording or computing numerically four reference intensity patterns R₁, R₂, R₃, and R₄ with the polarization and wavefront shape imaging system, each reference intensity pattern being generated by a respective impinging light beam, the four impinging reference light beams having flat wavefronts, normalised intensity and four known polarization states defining a non-zero volume in the Poincare sphere,
ii. Calculating the matrix C_{L}=( [symbol] Fᵢ|Fⱼ [symbol] _{L,G} [symbol] , C_{L}=( [symbol] Fᵢ|Fⱼ [symbol] _{L,G} [symbol] being the auto-correlation matrix constructed from both the reference intensity patterns and their respective gradients,
with:
$$\begin{matrix}{F}_{1} = {R}_{1} & {F}_{2} = {R}_{2} & {F}_{3} = {R}_{3} & {F}_{4} = {R}_{4} \\ {F}_{5} = {\partial }_{x} {R}_{1} & {F}_{6} = {\partial }_{x} {R}_{2} & {F}_{7} = {\partial }_{x} {R}_{3} & {F}_{8} = {\partial }_{x} {R}_{4} , \\ {F}_{9} = {\partial }_{y} {R}_{1} & {F}_{10} = {\partial }_{y} {R}_{2} & {F}_{11} = {\partial }_{y} {R}_{3} & {F}_{12} = {\partial }_{y} {R}_{4} ,\end{matrix}$$
and
iii. if C_{L} is not invertible or if the ratio of eigen-values eₘᵢₙ/eₘₐₓ of C_{L} is smaller than 1.5% or 1%, wherein eₘᵢₙ and eₘₐₓ are respectively the smallest and the largest eigen-values of the auto-correlation matrix C_{L}, modifying the unit cell of the polarized-resolved matrix of the polarization modulating mask and repeating steps i. and ii until the conditions of the step iii are fulfilled.

5. Method according to claim 1, wherein the intensity sensor camera comprises a pixilated surface, at least one subset of four reference intensity patterns among the at least four reference intensity patterns having the property to generate an invertible auto-correlation matrix C_{L}, the auto-correlation matrix being computed over at least one macropixel containing 20×20 camera pixels or less, advantageously 12×12 camera pixels or less, advantageously 6×6 camera pixels or less, more advantageously 3×3 camera pixels or less.

6. Method according to claim 1, wherein the polarization modulating mask is configured to cause the intensity image Iₛₑₙₛₒᵣ to depend on the wavefront shape of the incident light beam, a tilt applied to the wavefront shape resulting in a displacement amount of the intensity image Iₛₑₙₛₒᵣ.

7. Method according to claim 1, wherein the set of reference intensity patterns comprises N reference intensity patterns (Rₚ)_{p∈[1:N]}, N being larger than or equal to 4,
the step (C) comprising:
(C.1) computing polarization weights data A=(αₚ)_{p∈[1:N]} and deformation data (sₚ) of each given reference intensity pattern, for the single intensity image Iₛₑₙₛₒᵣ, by running a reconstruction algorithm minimizing the difference between Iₛₑₙₛₒᵣ(rⱼ) and
$${\sum }_{p = 1}^{N} {α}_{p} ( {r}_{j} ) {R}_{p} ( {r}_{j} + {s}_{p , j} ) .$$
j being a given camera pixel of the intensity sensor camera, rⱼ being said pixel coordinate at the camera sensing plane, Fₚ being the reference pattern of polarization state p,
sₚ being a deformation data representing the amount of relative displacement of the pattern Rₚ, s_{p,j} being proportional to the wavefront gradient of the fraction of signal light beam having polarization state p, the polarization weights data αₚ(r) and deformation data s_{p,j} being representative of a polarization state and a diffeomorphism, respectively, and
(C.2) calculating the Stokes parameters and the spatial phase of the incident light beam from the polarization weights data (αₚ) and deformation data (sₚ).

8. Method according to claim 1, wherein N reference intensity patterns R=(R_{y})_{p∈[1:N]}, N being larger than or equal to 4, are generated by N respective impinging reference light beams having any N known polarization states defining all together a polyhedron of non-zero volume when represented on the polarization Poincaré sphere, the polarization state of the N impinging reference light beams having known respective Stokes vector representations SR=(SRₚ)_{p∈[1:N]}, the step (C.2) comprising:
(C.2.1) Computing a measurement matrix W relating the Stokes vector representation of the impinging reference light beams to their corresponding reference intensity patterns according to the matrix equation: R=W×SR
(C.2.2) computing a Stokes parameter vector image S of the incident light beam (51) from the single intensity image Iₛₑₙₛₒᵣ by inverting the matrix equation W×S=Iₛₑₙₛₒᵣ or from the polarization weight data A=(αₚ)_{p∈[1:N]} by inverting the matrix equation: W×S=R×A.

9. Method according to claim 1, wherein the polarization modulating mask has the property to generate several sets of four reference intensity patterns at respective several working distances (d) from the input plane of the polarization modulating mask, when illuminated by four respective impinging reference light beams, one set of four reference intensity patterns per working distance, the four impinging reference light beams having polarization states defining all together a tetrahedron of non-zero volume when represented on the polarization Poincaré sphere, and each said set of four reference intensity patterns forming a Stokes parameters image basis, meaning that the auto-correlation matrix C_{L} of the corresponding four reference intensity patterns is invertible, so allowing the working distance (d) to be changed to improve sensitivity to weak wavefront deformations, and/or to improve spatial resolution, and/or to maximize the orthogonality of the four reference intensity patterns, notably by maximizing the minimum eigen-value of an auto-correlation matrix C_{L} involving all reference intensity patterns.

10. Method according to claim 1, wherein the unit cell of the polarization modulating mask comprises a plurality of polarization modulating domains, each polarization modulating domain having a uniform polarization-resolved matrix over said polarization modulating domain, the polarization modulating domains being notably randomly arranged or periodically arranged in a lattice in the unit cell.

11. Method according to claim 7, wherein each unit cell comprises four square adjacent polarization modulating domains arranged in rows and columns, the four square adjacent polarization modulating domains having preferentially a linear retardance of π/2±π/4 radians and a relative fast axes orientations rotating by {+π/3+π/3 −π/3 −π/3} radians, or equivalently absolute fast axes orientation of {α; α+π/3; α +2/3; α +π/3}, α being an angle, when running around the four adjacent domains clockwise or counter-clockwise, the tolerance on fast-axes orientations being ±π/6 rad.

12. (canceled)

13. (canceled)

14. (canceled)

15. A polarization imaging system for generating data related at least to the polarization state and the polarization rate, and advantageously to the wavefront shapes, of an incident light beam of any polarization state and any polarization rate, from a single intensity image acquisition Iₛₑₙₛₒᵣ of said light beam, which comprises:
a polarization modulating mask being a diffractive optical element comprising a two-dimensional birefringent diffraction grating having any structure of any of the five possible two-dimensional Bravais lattices: oblique lattice, square lattice, rectangular lattice, hexagonal lattice or rhombic lattice, the two-dimensional a periodic lattice being periodic along two transverse dimensions with at least one transverse period w and based on an unit cell, each unit cell exhibiting a two-dimensional birefringent motif, advantageously with a unit cell being a square unit cell with the size of the side w, the polarization modulating mask being thinner than one tenth of the Rayleigh distance of the mask z_{R}, with z_{R}=πw²/λ_{average}, λ_{average} being the average wavelength of the incident light beam,
said polarization modulating mask having:
a polarization-resolved transmission or reflection matrix T, and
the property to generate interference patterns between any two cross-polarized impinging beams, at several planes transverse to the propagation axis, the several transverse planes lying at several working distances (d) from said polarization modulating mask,
the interference patterns so depending on the two respective amplitudes and the relative phase of said two cross-polarized impinging beams, and
the property to generate at least one set of four reference intensity patterns, at least at one working distance (d) from the polarization modulation mask, when illuminated by four respective impinging reference light beams, one set of four reference intensity patterns per working distance,
said reference intensity patterns exhibiting structures of size w or smaller at said working distance (d),
the working distance (d) being smaller than one tenth of wL/λ_{average}, with L the diagonal length of a captor of the intensity sensor camera and λ_{average} the average wavelength of the incident light beam,
the four impinging reference light beams having polarization states defining all together a tetrahedron of non-zero volume when represented on the polarization Poincaré sphere,
and each said set of four reference intensity patterns forming a Stokes parameters image basis, meaning that the auto-correlation matrix C_{L}=( [symbol] Rᵢ|Rⱼ [symbol] _{L,G} [symbol] of the corresponding four reference intensity patterns is invertible,
Ri being the reference pattern of polarization state i,
an intensity sensor camera being placed downstream from said polarization modulating mask for recording the intensity image Iₛₑₙₛₒᵣ of the incident light beam, at least a part of which having been reflected by or transmitted through the polarization modulating mask, or alternatively at least a part of the incident light beam having interfered with another beam reflected by or transmitted through the polarization modulating mask, said intensity image Iₛₑₙₛₒᵣ lying at any of the several of said working distances (d) from the input plane of the polarization modulating mask,
storage and computing means for:
(a) recording one set of at least four reference intensity patterns with the intensity sensor camera of the imaging system, the reference intensity patterns being formed at one given of said working distances (d) from the input plane of the polarization modulating mask,
each reference intensity pattern having been generated by a respective impinging reference light beam of known non-zero polarization rate, known polarization state, and advantageously of known wavefront shape,
the polarization states of the impinging reference light beams defining all together a polyhedron of non-zero volume when represented on the polarization Poincaré sphere and reference intensity patterns defining a Stokes parameters image basis at the working distance (d),
thus allowing the determination of the full polarization state of the incident light beam,
(b) recording the single intensity image Iₛₑₙₛₒᵣ of said incident light beam with the intensity camera sensor, the single intensity image Iₛₑₙₛₒᵣ being formed at the same given working distance (d) from the input plane of the polarization modulating mask,
(c) processing the single intensity image Iₛₑₙₛₒᵣ based on the reference intensity patterns to generate the data related to the polarization state and the polarization rate, and advantageously to the wavefront shapes of the incident light beam.

16. System according to claim 15, wherein the intensity sensor camera is placed so that the intensity image Iₛₑₙₛₒᵣ is lying at a working distance (d) shorter than the Rayleigh distance of the mask πw²/λ_{average}, λ_{average} being the average wavelength of the incident light beam.

17. System according to claim 15, wherein the unit cells design of the polarization modulating mask is realized using the following algorithm:
i. recording or computing numerically four reference intensity patterns R₁, R₂, R₃, and R₄ with the polarization and imaging system, each reference intensity pattern being generated by a respective impinging light beam, the four impinging reference light beams having normalised intensity and four known polarization states defining a non-zero volume in the Poincare sphere
ii. Calculating the auto-correlation matrix C_{L}=( [symbol] Rᵢ|Rⱼ [symbol] _{L,G} [symbol] , where Rₚ are the reference intensity patterns recorded for the reference intensity light beam and
iii. If C_{L} is not invertible or if the ratio of eigen-values eₘᵢₙ/eₘₐₓ of C_{L} is smaller than 1.5% or 1%, wherein eₘᵢₙ and eₘₐₓ are respectively the smallest and the largest eigen-values of the auto-correlation matrix C_{L}, modifying the unit cells of the polarized-resolved matrix of the polarization modulating mask and repeating steps i. and ii. until the conditions of the step iii. are fulfilled.

18. System according to claim 15, wherein the unit cells design of the polarization modulating mask is realized using the following algorithm:
i. recording or computing numerically four reference intensity patterns R₁, R₂, R₃, and R₄ with the polarization and wavefront shape imaging system, each reference intensity pattern being generated by a respective impinging light beam, the four impinging reference light beams having flat wavefronts, normalised intensity and four known polarization states defining a non-zero volume in the Poincare sphere
ii. Calculating the matrix C_{L}=( [symbol] Fᵢ|Fⱼ [symbol] _{L,G} [symbol] , C_{L}=( [symbol] Fᵢ|Fⱼ [symbol] _{L,G} [symbol] being the auto-correlation matrix constructed from both the reference intensity patterns and their respective gradients,
with:
$$\begin{matrix}{F}_{1} = {R}_{1} & {F}_{2} = {R}_{2} & {F}_{3} = {R}_{3} & {F}_{4} = {R}_{4} \\ {F}_{5} = {\partial }_{x} {R}_{1} & {F}_{6} = {\partial }_{x} {R}_{2} & {F}_{7} = {\partial }_{x} {R}_{3} & {F}_{8} = {\partial }_{x} {R}_{4} , \\ {F}_{9} = {\partial }_{y} {R}_{1} & {F}_{10} = {\partial }_{y} {R}_{2} & {F}_{11} = {\partial }_{y} {R}_{3} & {F}_{12} = {\partial }_{y} {R}_{4} ,\end{matrix}$$
and
iii. If C_{L} is not invertible or if the ratio of eigen-values eₘᵢₙ/eₘₐₓ of C_{L} is smaller than 1.5% or 1%, wherein eₘᵢₙ and eₘₐₓ are respectively the smallest and the largest eigen-values of the auto-correlation matrix C, modifying the polarized-resolved matrix of the polarization modulating mask and repeating steps i. and ii. until the conditions of the step iii are fulfilled.

19. System according to any one of claim 15, wherein the intensity sensor camera comprises a pixilated surface, at least one subset of four reference intensity patterns among the at least four reference intensity patterns having the property to generate an invertible auto-correlation matrix C_{L}, the auto-correlation matrix being computed over at least one macropixel containing less than 20×20 camera pixels, better less than 12×12 camera pixels, better less than 6×6 camera pixels, even better less than 3×3 camera pixels.

20. System according to claim 15, wherein the set of reference intensity patterns comprises N reference intensity patterns (Rₚ)_{p∈[1:N]}, N being larger than or equal to 4,
the storage and computing means are configured for in the step (c):
(c.1) computing polarization weights data A=(α_{P})_{p∈[1:n]} and deformation data (sₚ) of each given reference intensity pattern, for the single intensity image, by running a reconstruction algorithm minimizing the difference between Iₛₑₙₛₒᵣ(rⱼ) and,
$${\sum }_{p = 1}^{N} {α}_{p} ( {r}_{j} ) {R}_{p} ( {r}_{j} + {s}_{p , j} ) .$$
j being a given camera pixel of the intensity sensor camera, rⱼ being said pixel coordinate at the camera sensing plane, Rₚ being the reference pattern of polarization state p,
sₚ being a deformation data representing the amount of relative displacement of the pattern Rₚ, sₚ being proportional to the wavefront gradient of the fraction of signal light beam having polarization state p, the polarization weights data αₚ(r) and deformation data sₚ being representative of a polarization state and a diffeomorphism, respectively, and
(c.2) calculating the Stokes parameters and the spatial phase of the incident light beam from the polarization weights data (αₚ) and deformation data (sₚ).

21. System according to claim 15, wherein the polarization modulating mask comprises a plurality of polarization modulating domains, each polarization modulating domain having a uniform polarization-resolved matrix over said polarization modulating domain, the polarization modulating domains being for instance randomly arranged or periodically arranged in a lattice in the polarization modulating mask.

22. System according to claim 15, wherein each unit cell comprising four square adjacent polarization modulating domains arranged in rows and columns, the four adjacent polarization modulating domains having preferentially a linear retardance of π/2±π/4 rad and relative fast axes orientations rotating by {+π/3 +π/3 −π/3 −π/3} radians, or equivalently absolute fast axes orientation of {α; α+π/3; α +2π/3; α +π/3}, when running around the four adjacent domains clockwise or counter-clockwise, α being an angle, the tolerance on fast-axes orientations being ±π/6 rad.

23. System according to claim 15, wherein the polarization modulating mask comprises—chiral and/or non-chiral liquid crystals, each liquid crystal being characterized by its alignment.

24. System according to claim 15, wherein the polarization modulating mask is chosen among the group made of: a liquid-crystal thin film, with liquid crystals orientations tailored according to a periodic lattice of a unit cell, potentially exhibiting topological dislocations, a liquid crystal thin film with electro-optical control to tune the device performances, a birefringent poly-crystalline structure, a meta-surface made of metallic or dielectric nano-structures, in particular the polarization modulating mask being made of metamaterials or any birefringent material, like liquid crystal cells, which maximize the modulation rate of the incident beam.

25. A polarization modulating mask comprising a diffraction grating consisting in a periodic two-dimensional lattice based on a unit cell, each unit cell comprising a plurality of polarization modulating or birefringent domains, the unit cell comprising four adjacent polarization modulating domains arranged in rows and columns, the four adjacent polarization modulating domains having a linear retardance of π/2 ±π/4 rad and their relative fast axes orientations rotating by {+π/3 +π/3 −π/3 −π/3} radians, or equivalently absolute fast axes orientation of {α; α+π/3; α +2π/3; α +π/3} radians, when running around the four adjacent domains clockwise or counter-clockwise, α being an angle, the tolerance on fast-axes orientations being ±π/6 rad.

26. (canceled)
